(19) United States
(12) Patent Application Publication
(10) Pub. No.: US 2025/0040471 A1
(43) Pub. Date: Feb. 6, 2025

(54) Seed Meter with Seed Retaining Structure

(71) Applicant: Precision Planting LLC, Tremont, IL (US)

(72) Inventors: Timothy Schwind, Eureka, IL (US); William Frank, Manito, IL (US); Luke Stuber, Tremont, IL (US)

(21) Appl. No.: 18/691,180

(22) PCT Filed: Sep. 23, 2022
(86) PCT No.: PCT/IB2022/059043

§ 371 Date: Mar. 12, 2024

Related U.S. Application Data
(60) Provisional application No. 63/262,512, filed on Oct. 14, 2021.

(51) Int. Cl. A01C 7/04

(52) U.S. Cl. CPC A01C 7/046; A01C 7/0443

(57) ABSTRACT

A seed meter (100) includes a housing (110) and a cover (112). A seed disc (130) is rotatably disposed between the housing (110) and the cover (112). The housing (110) includes a seed pool area (114) and a seed exit chute (104) separated by a generally vertical brush (212) on a seed-side of the seed disc (130). A seed retaining structure (200) disposed on the seed-side of the seed disc (130) within the housing (110) prevents the seed within the seed pool area (114) from passing over the generally vertical brush (212) from the seed pool area (114) into the seed exit chute (104) when the seed meter (100) is tilted or rotated.

### CROSS REFERENCE TO RELATED APPLICATIONS

This application claims priority to U.S. Provisional Application No. 63/262,512, filed 14 Oct. 2021, which is incorporated herein by reference in its entirety.

### BACKGROUND

While the various seed meters on the market serve their intended purpose, there is a need for a seed meter that includes internal structure to prevent seeds that may remain in the seed meter from inadvertently falling out of the seed meter when the seed meter is being removed from the planter row unit or when the planter is being folded or transported or under certain planting conditions.

### BRIEF DESCRIPTION OF THE DRAWINGS

FIG. 1A is a left side elevation view of an embodiment of an existing planter row unit with a seed tube in an operating position.

FIG. 1B is a right side elevation view of the existing planter row unit of FIG. 1A in the operating position.

FIG. 1C is a left side elevation view of the existing planter row unit of FIG. 1A showing the hopper and seed meter being removed from the row unit.

FIG. 2A is a left side elevation view of an embodiment of an existing planter row unit with a seed conveyor in an operating position.

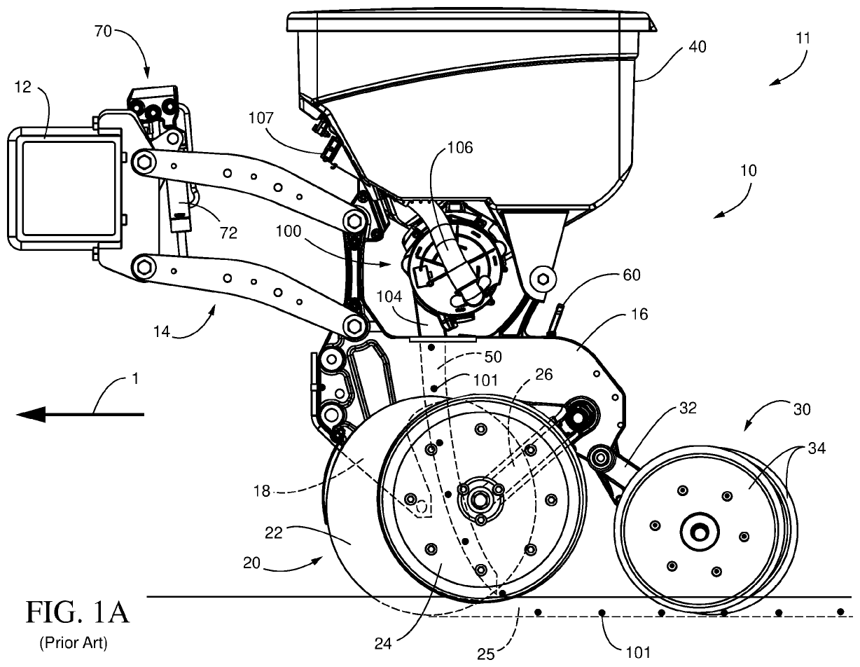

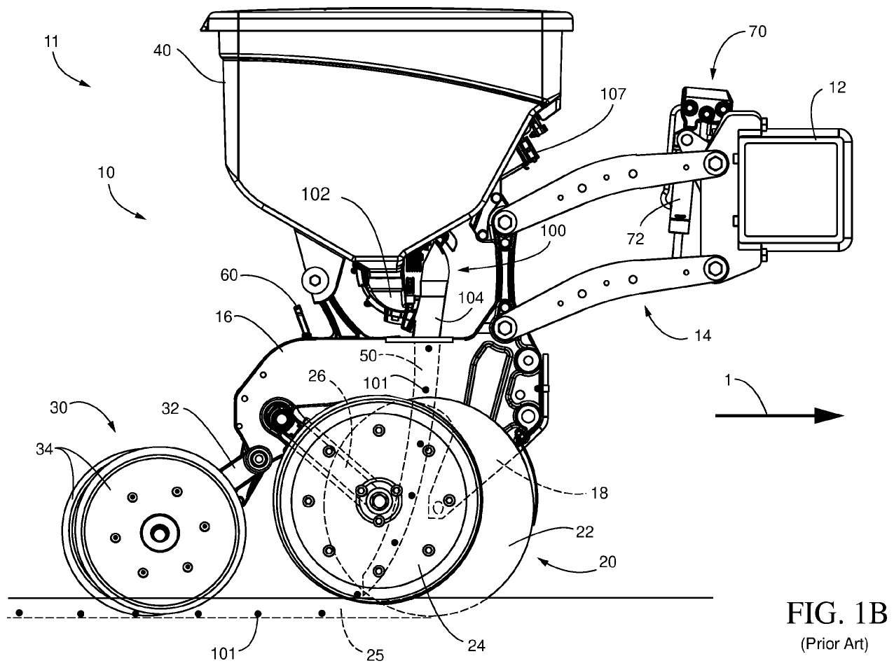

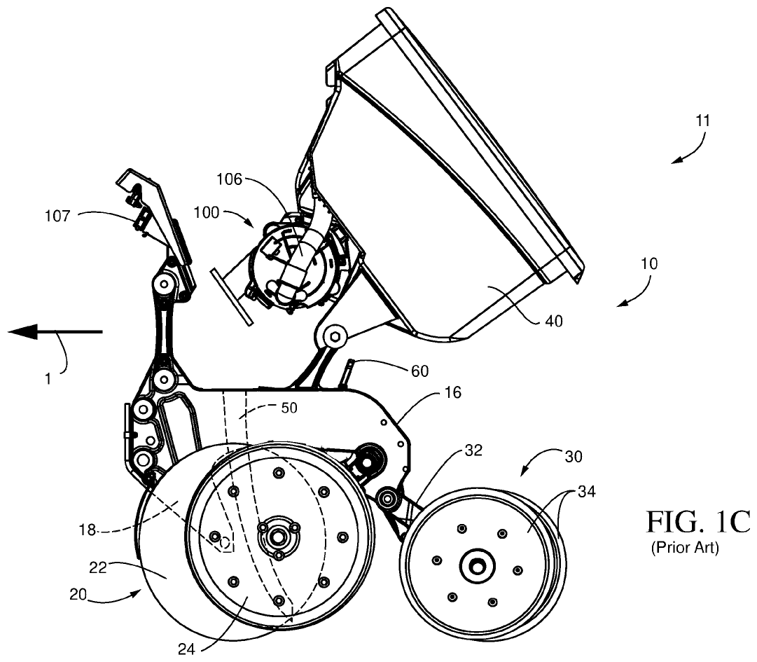

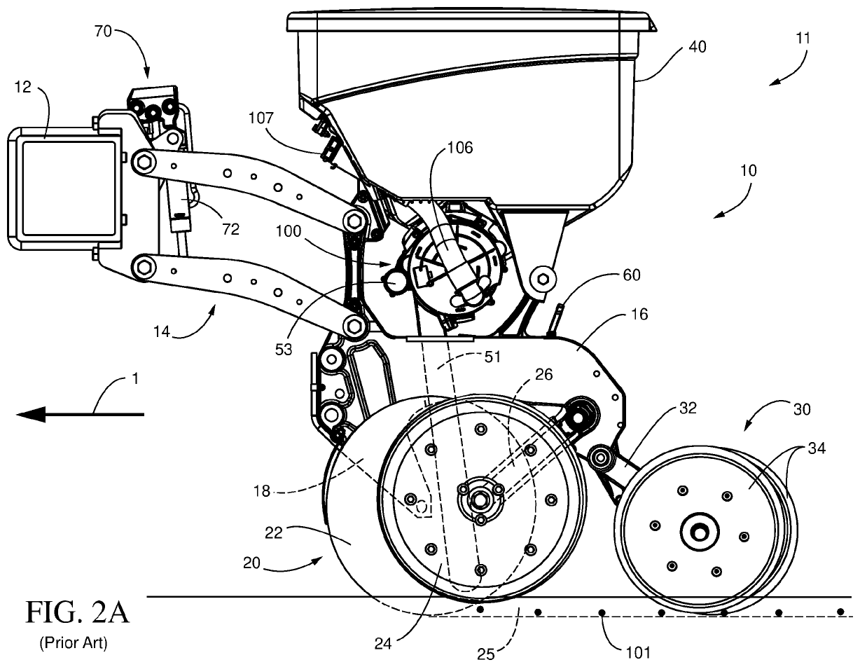

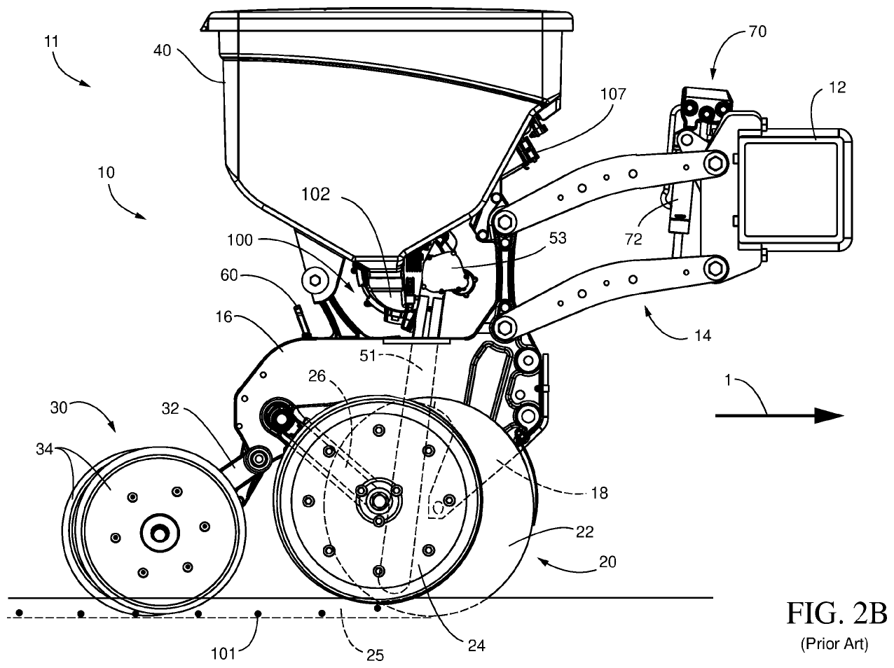

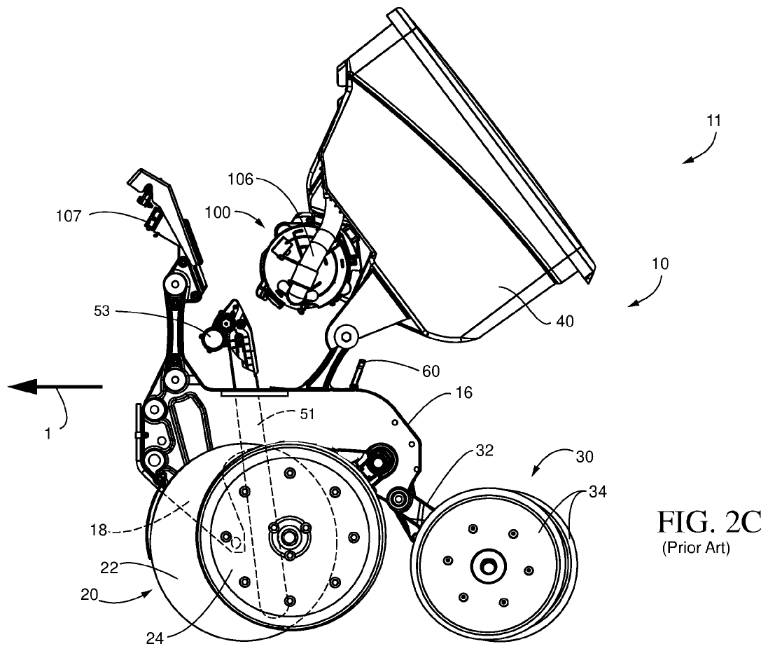

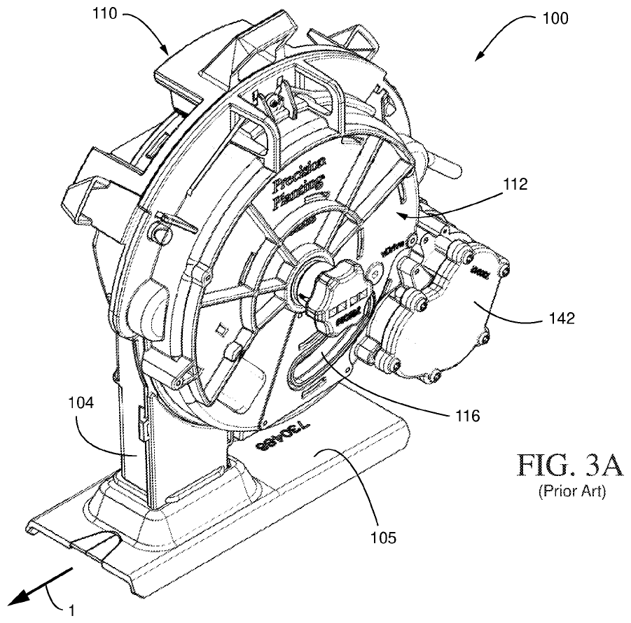

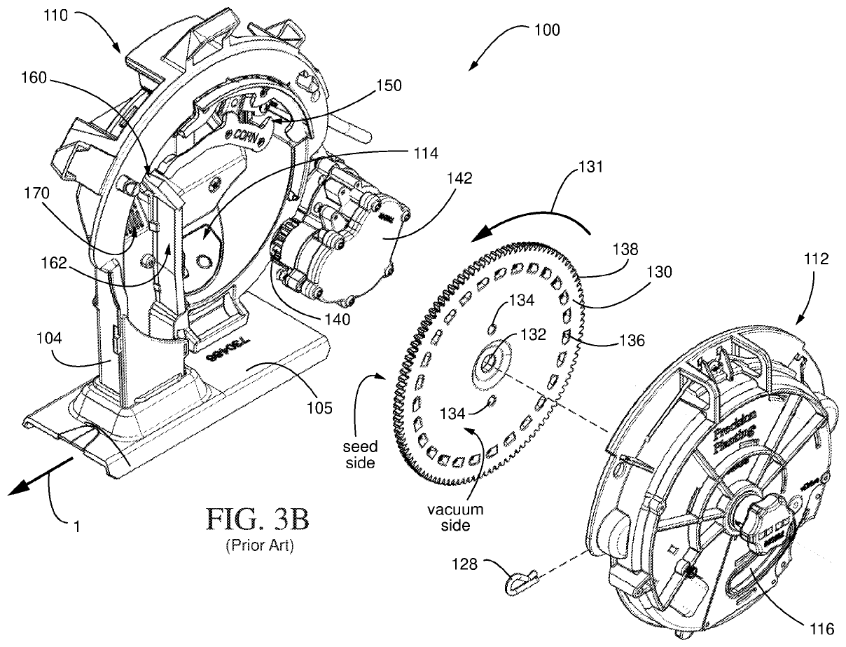

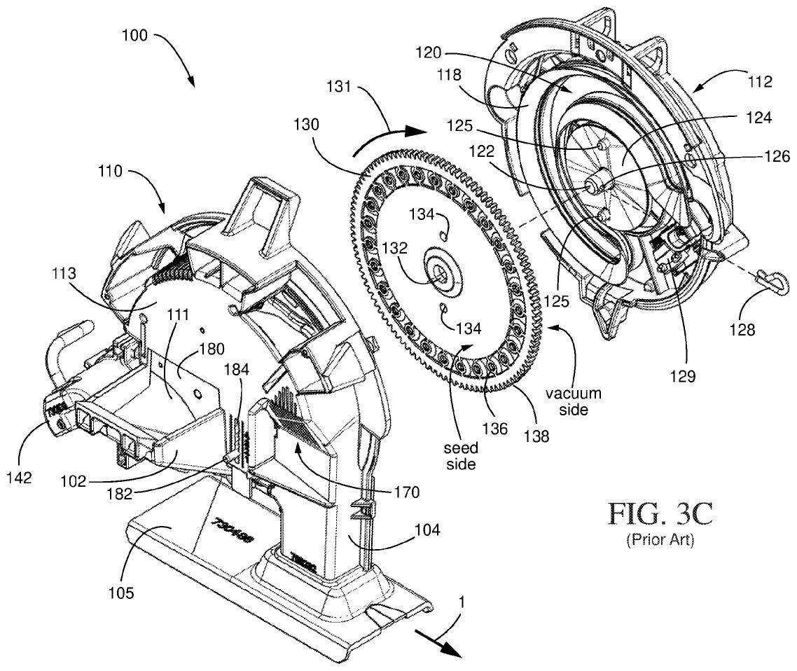

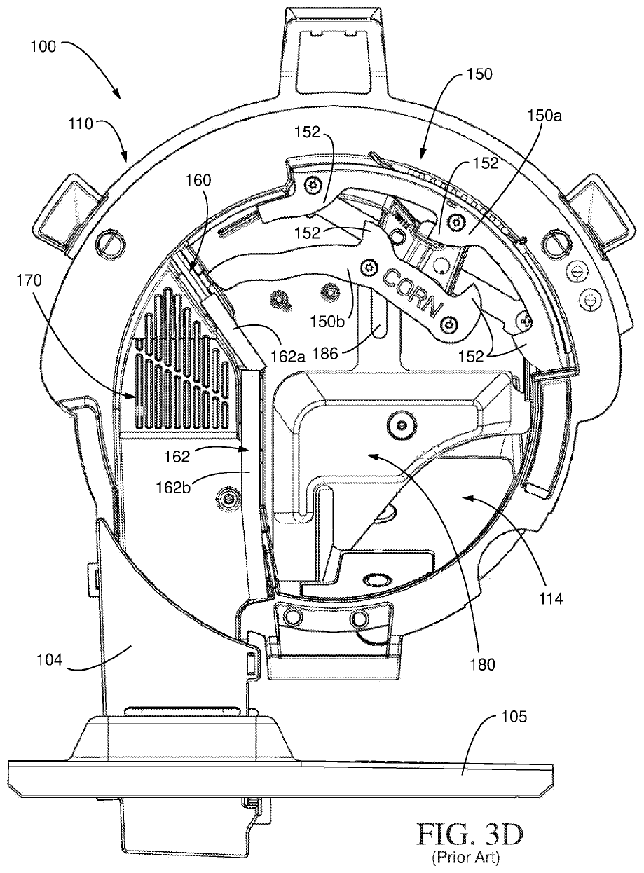

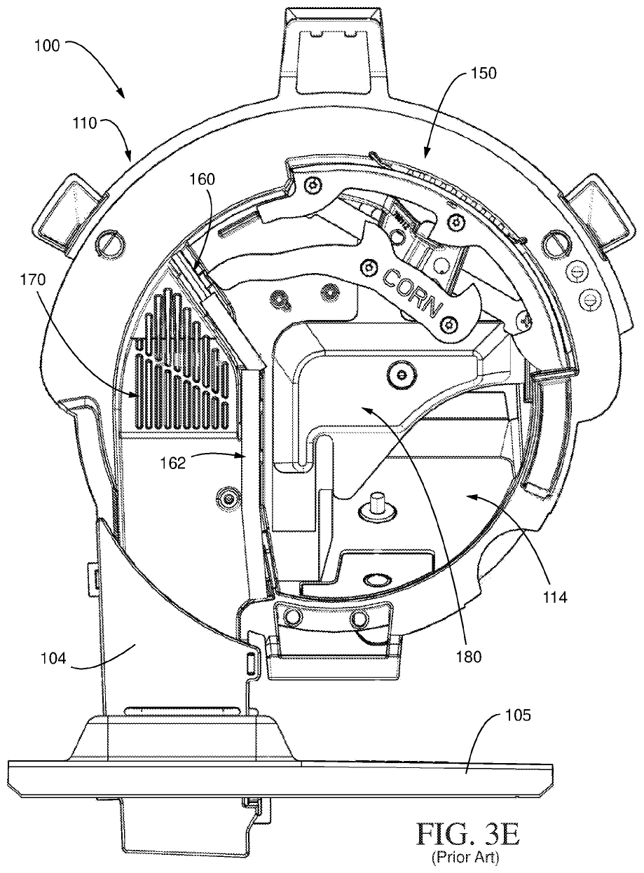

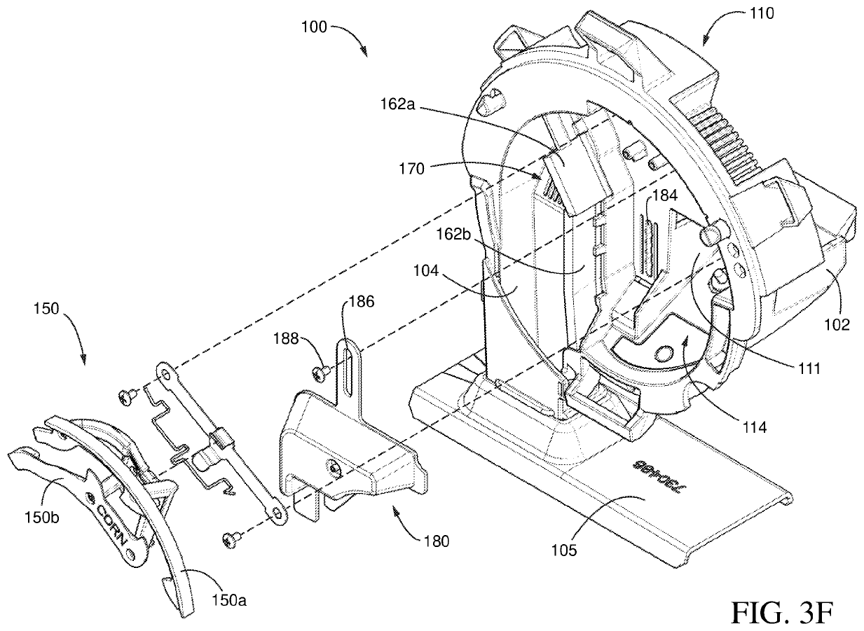

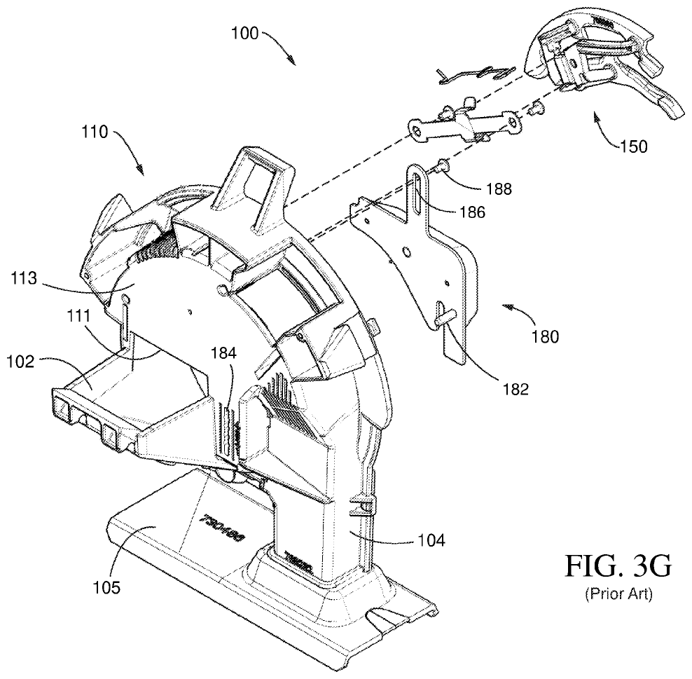

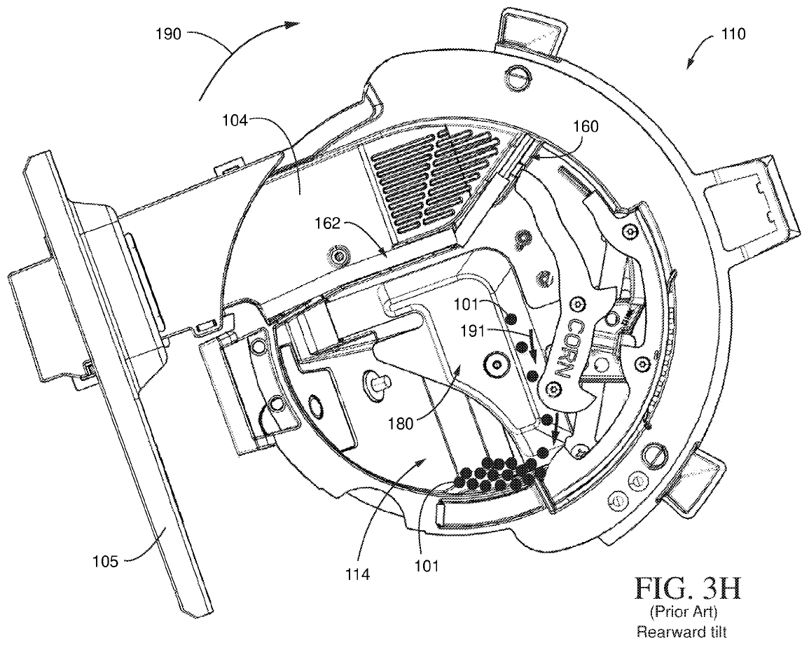

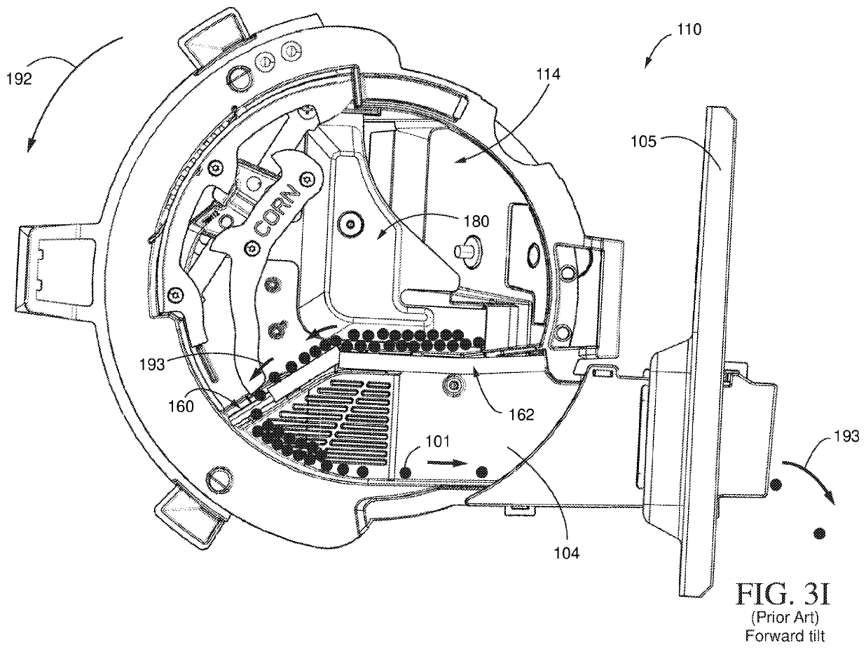

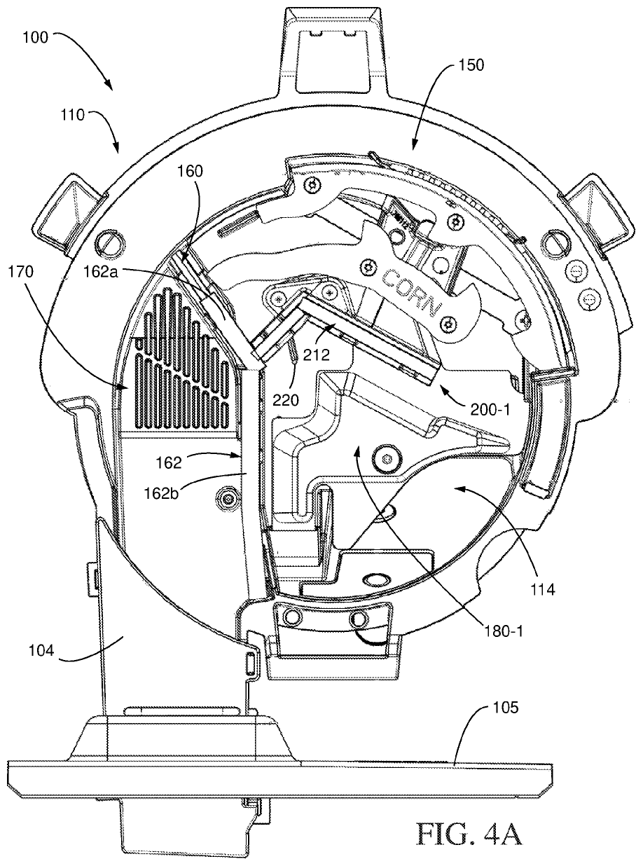

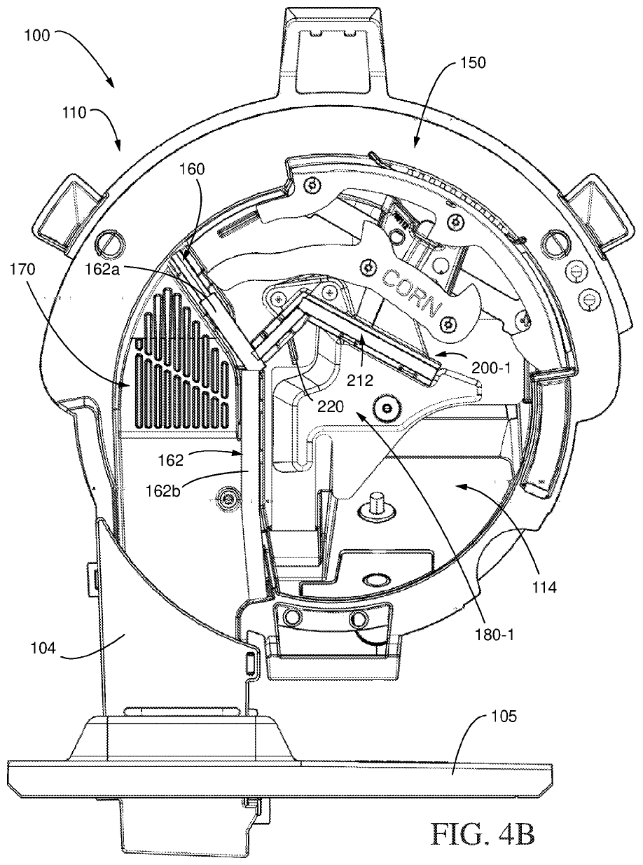

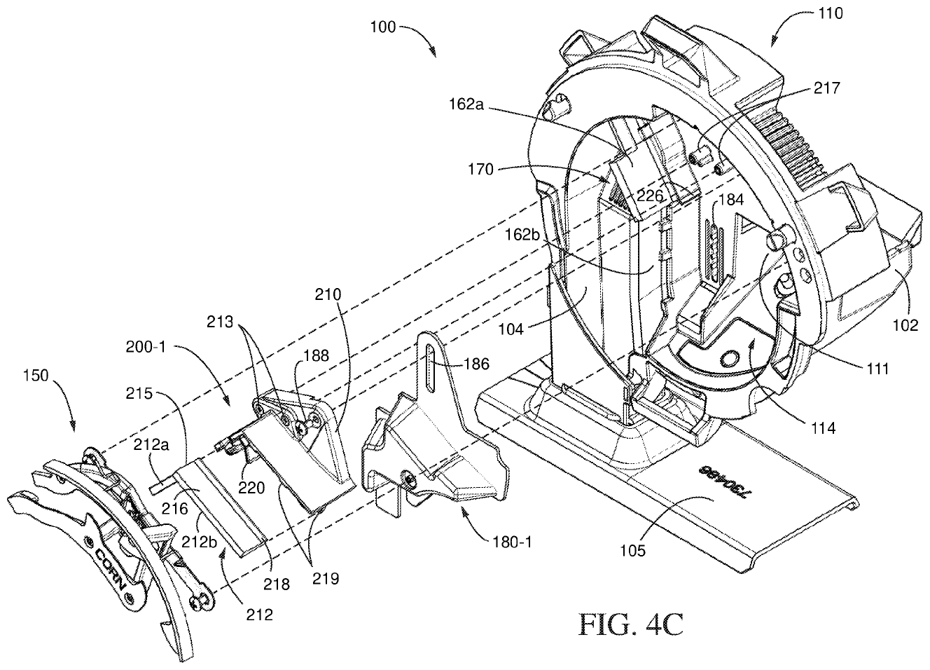

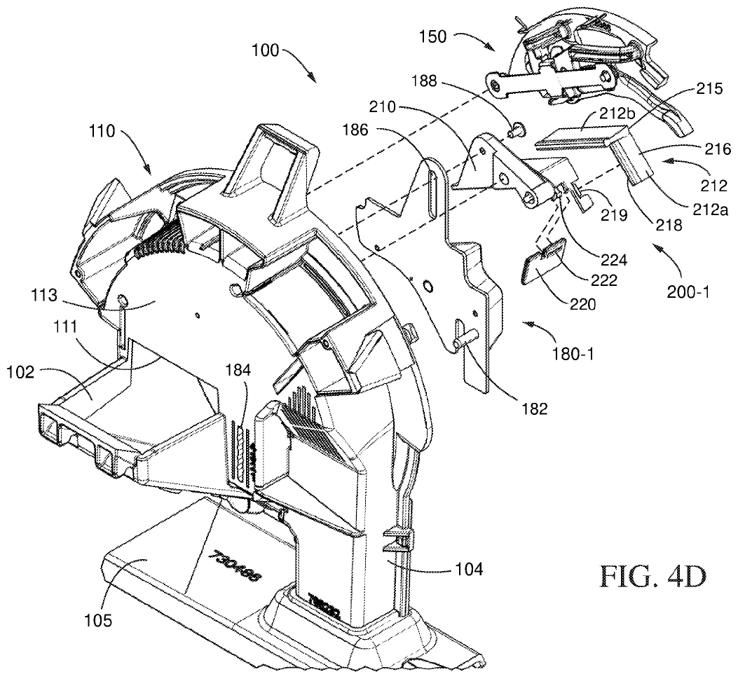

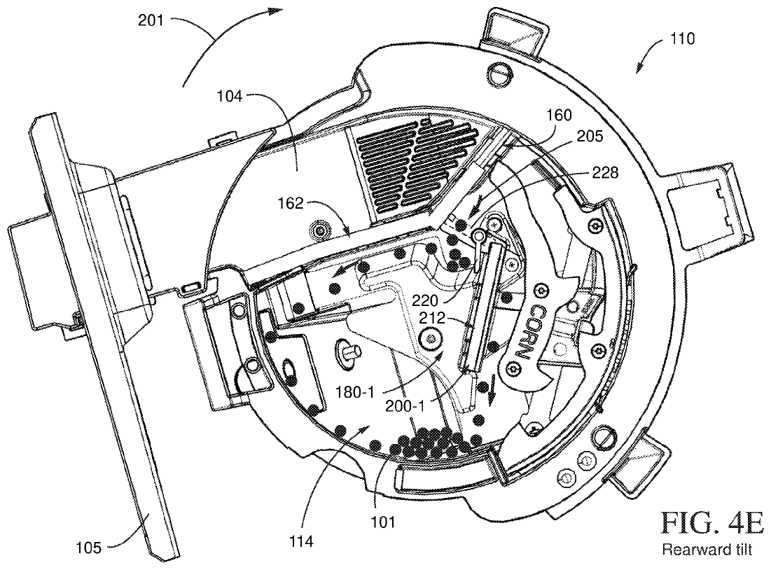

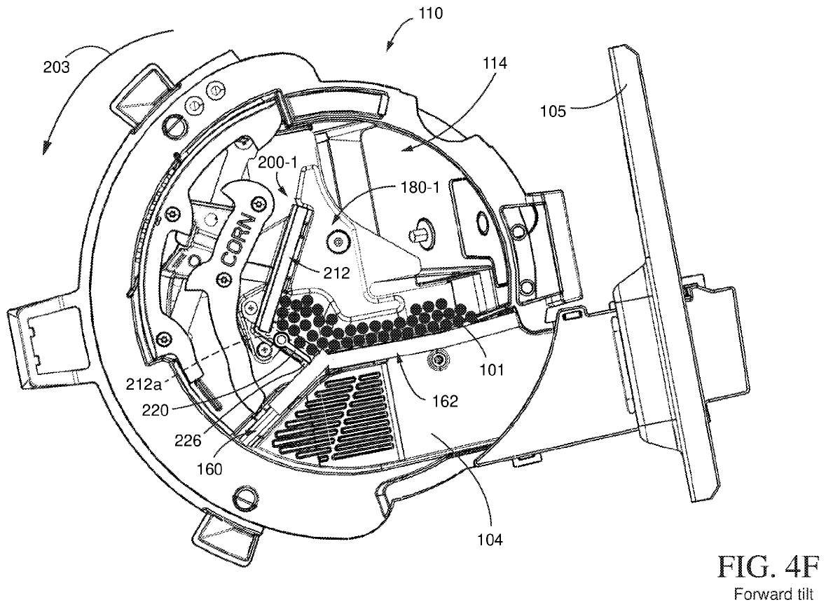

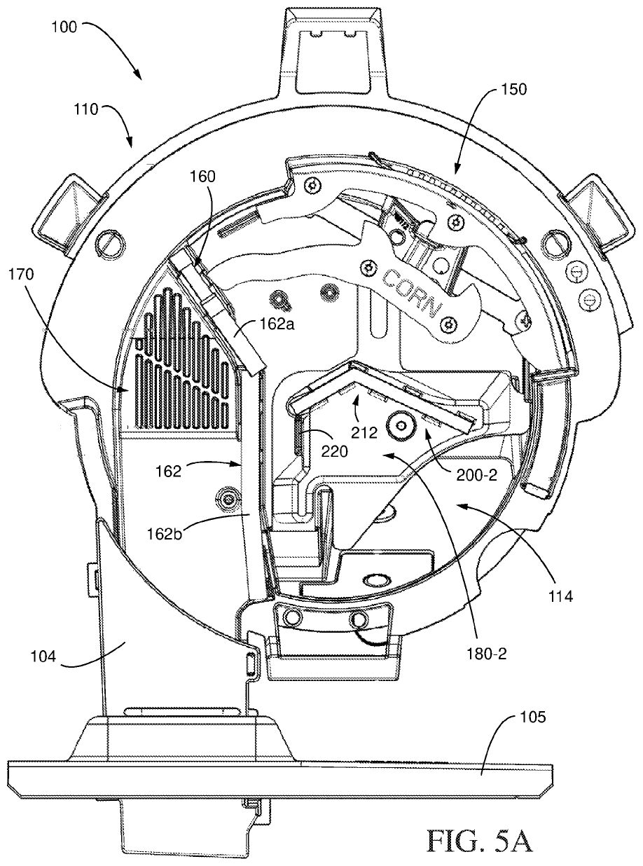

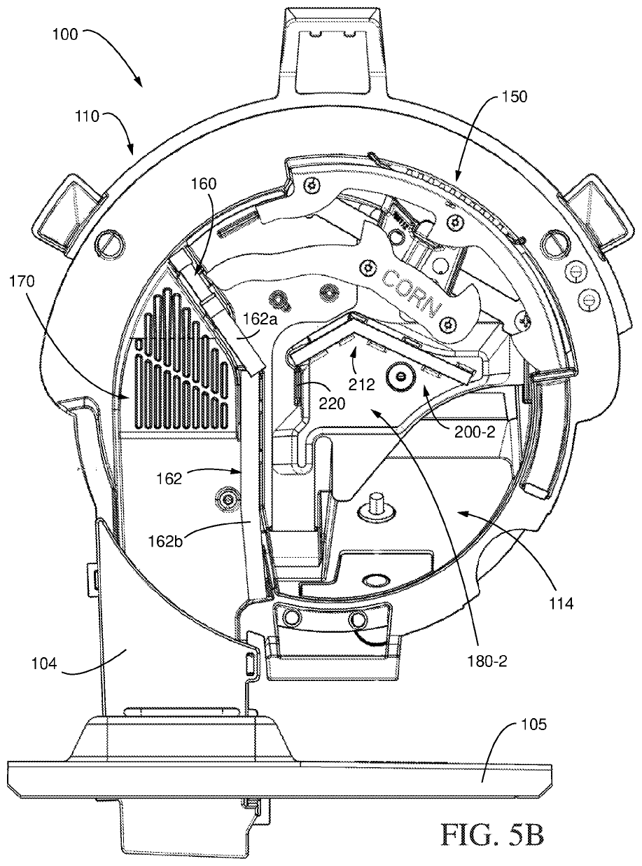

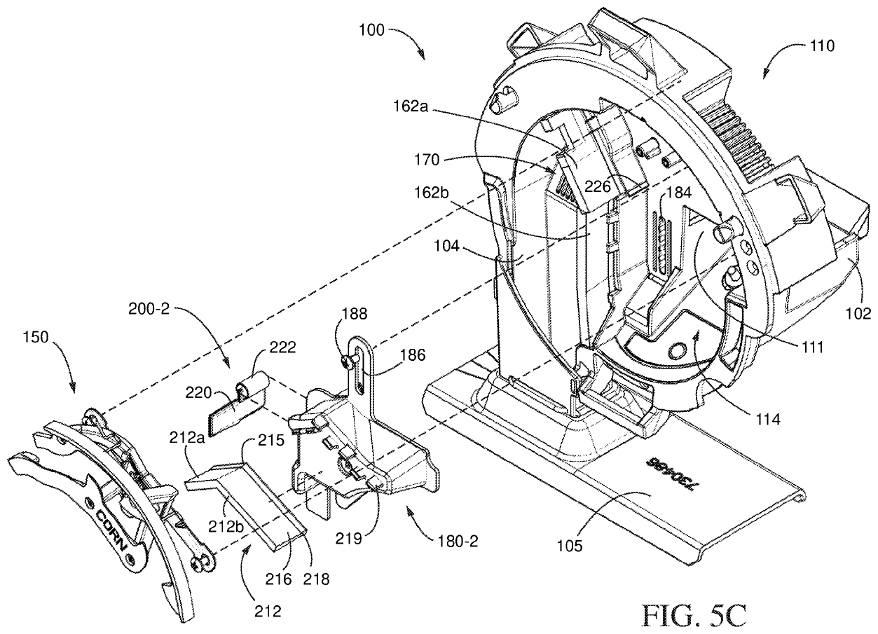

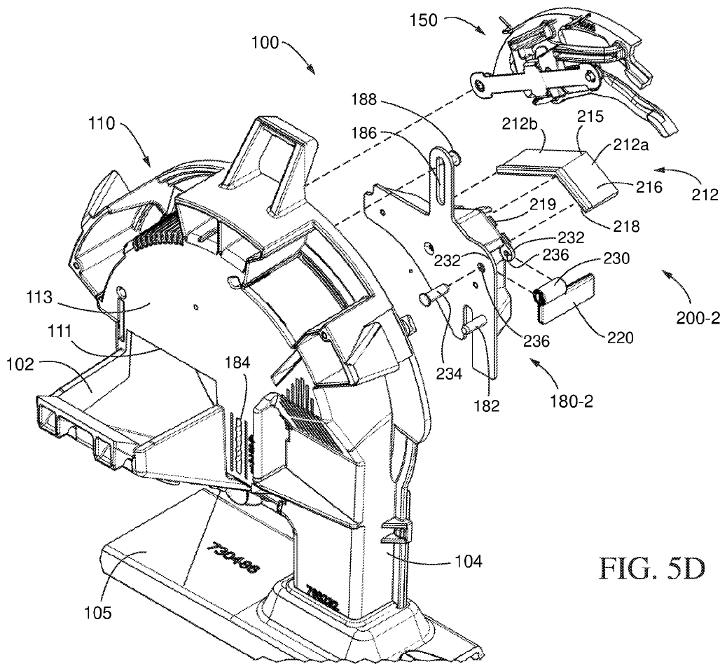

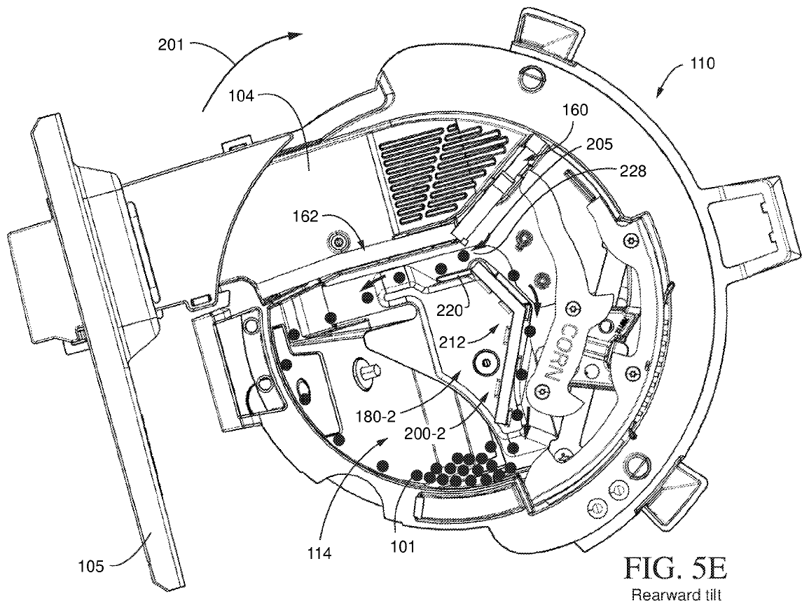

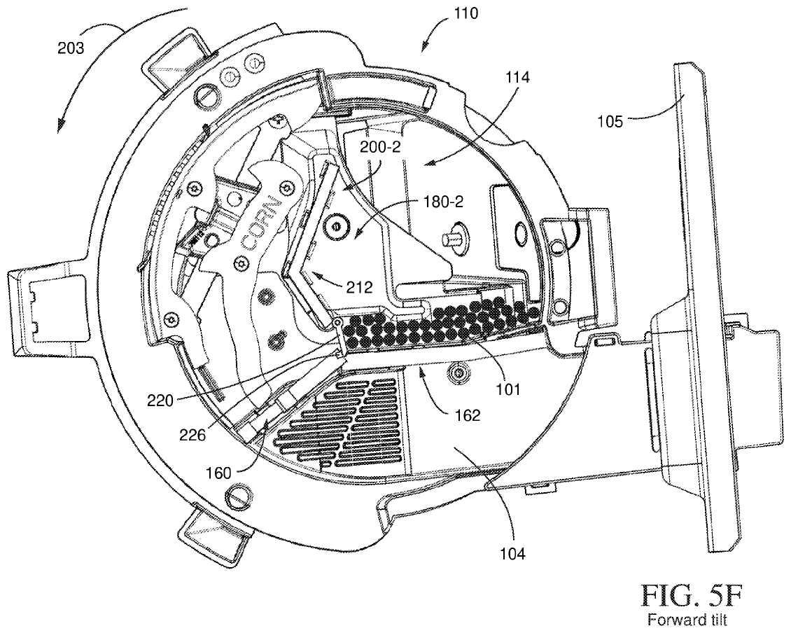

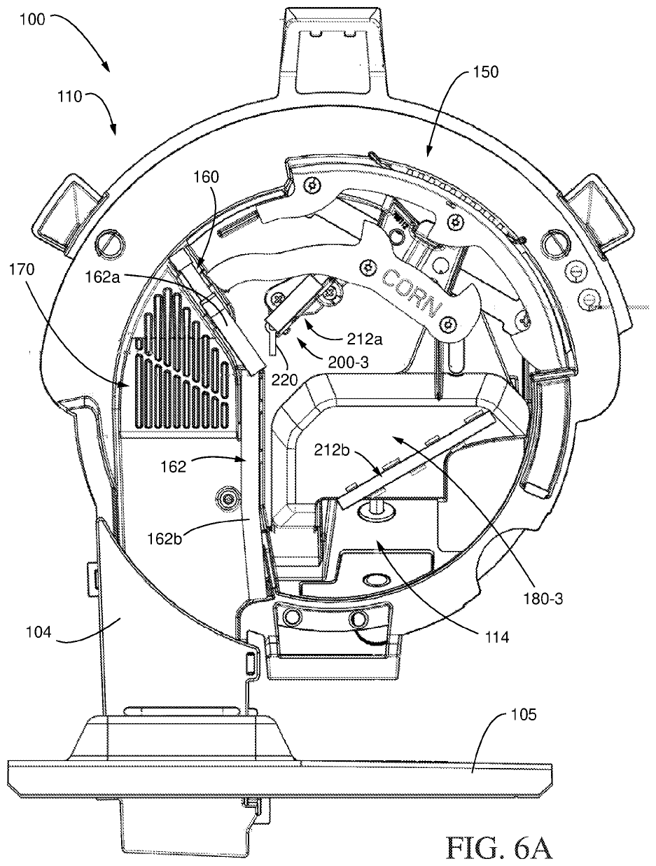

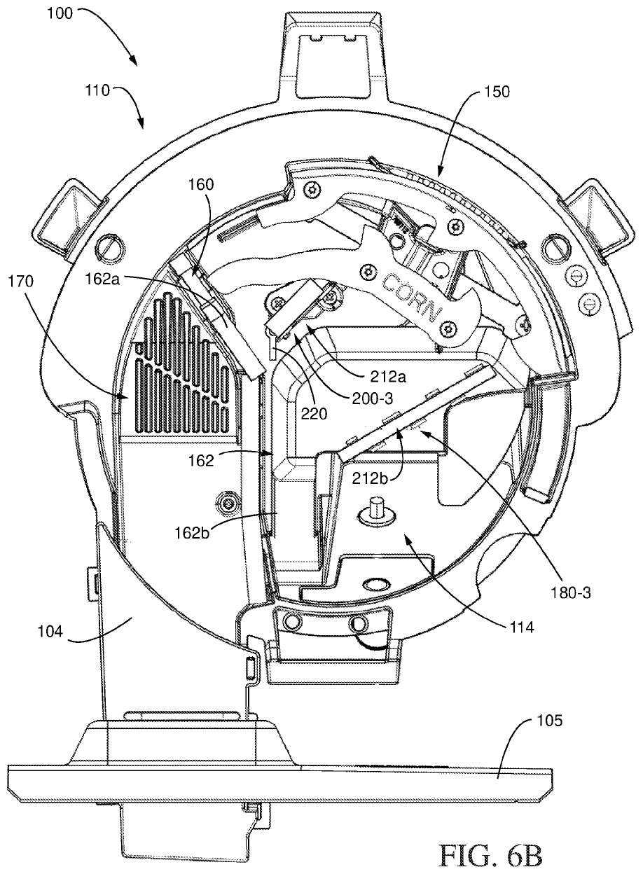

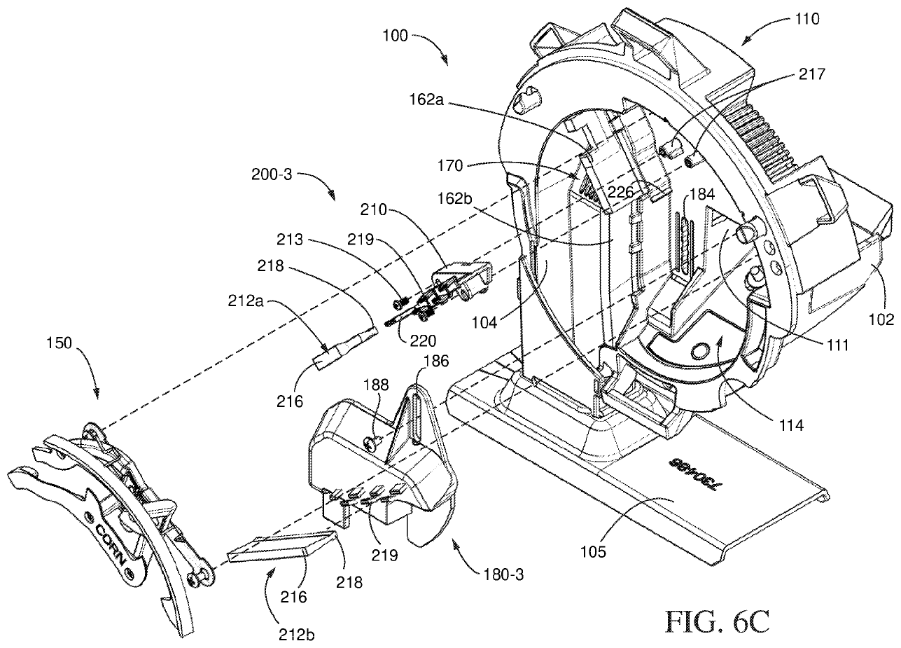

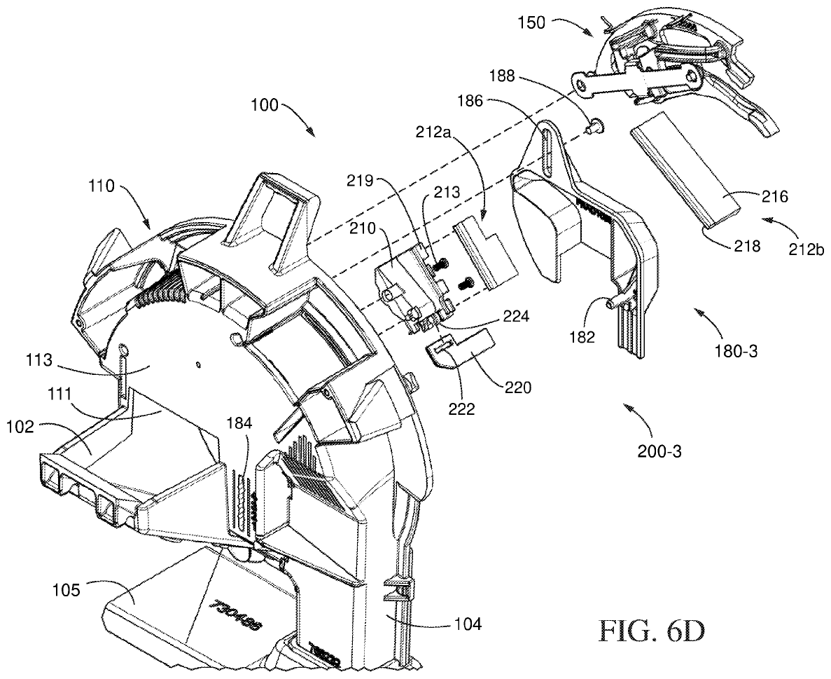

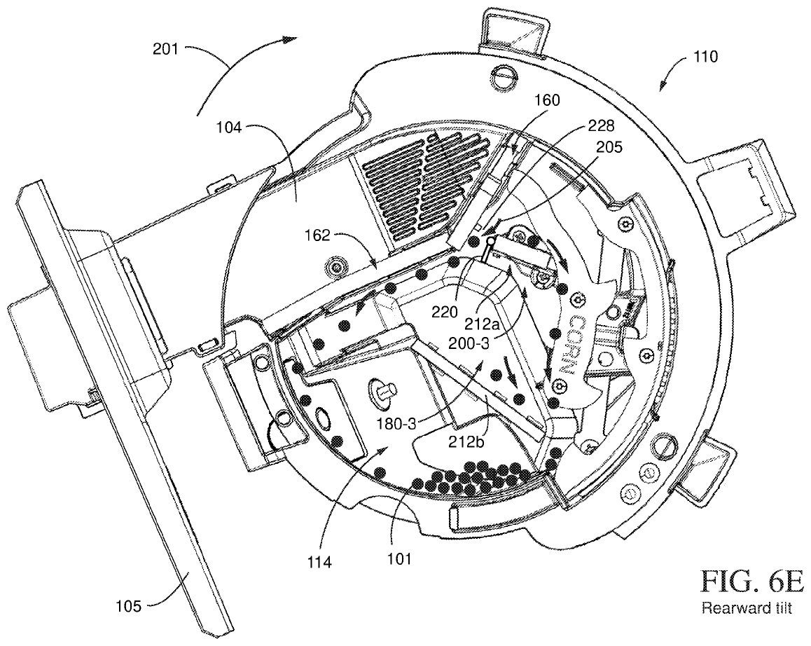

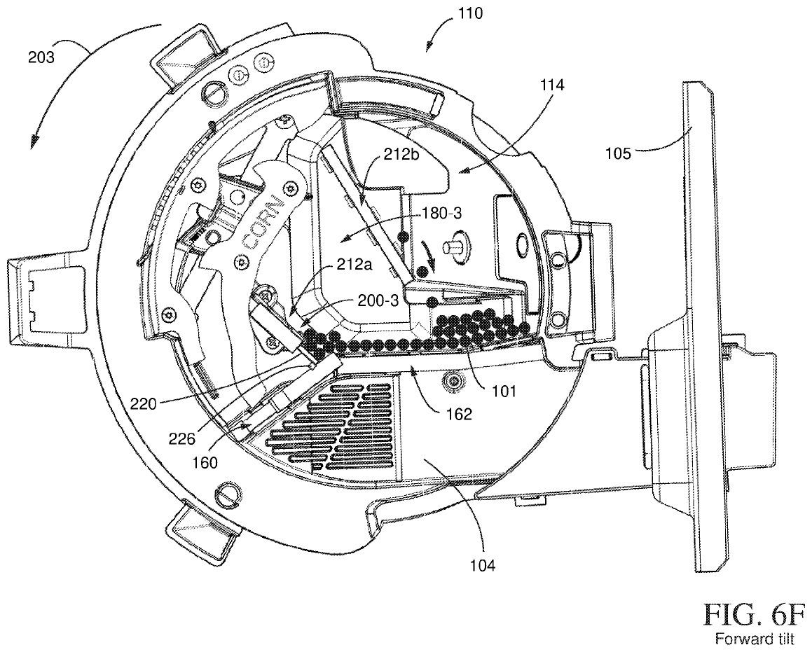

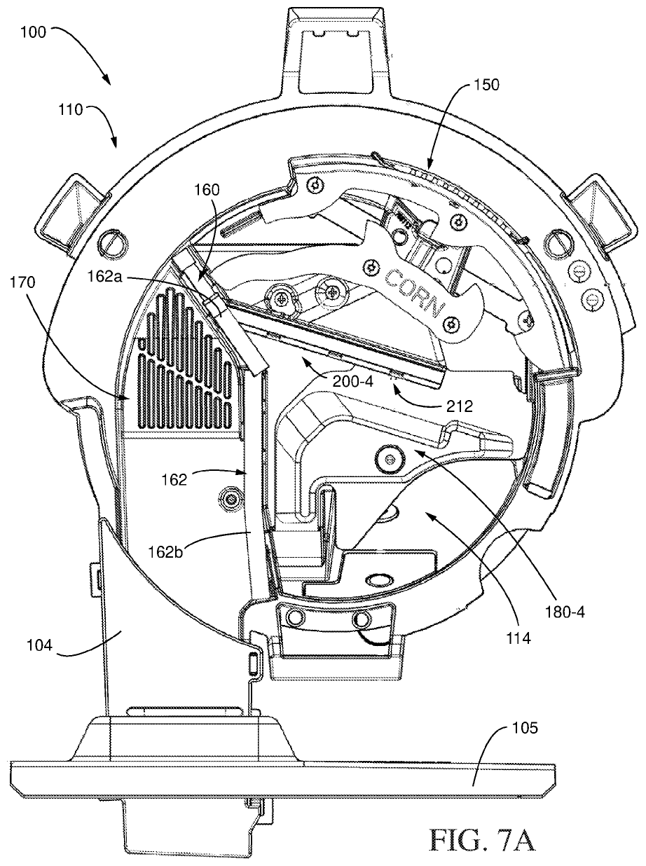

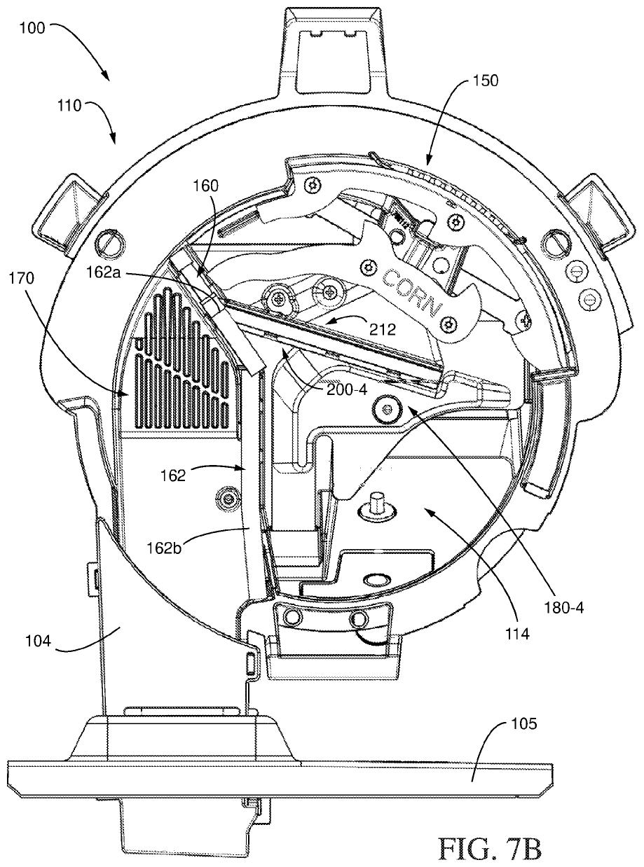

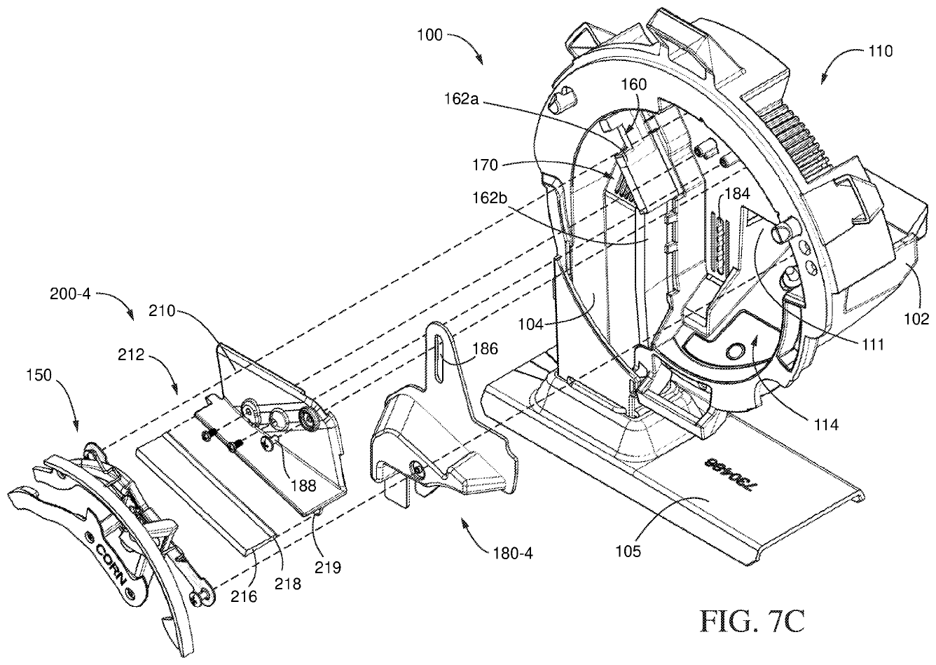

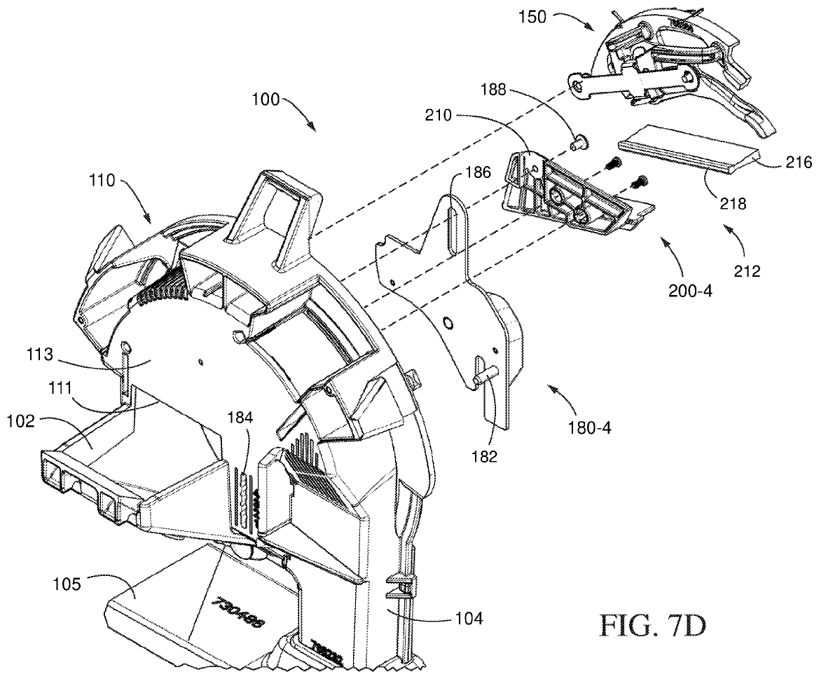

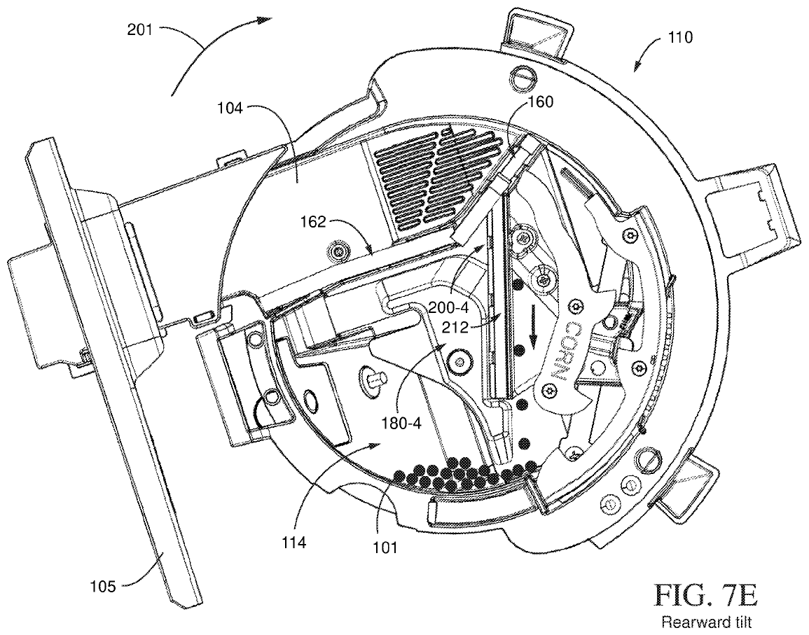

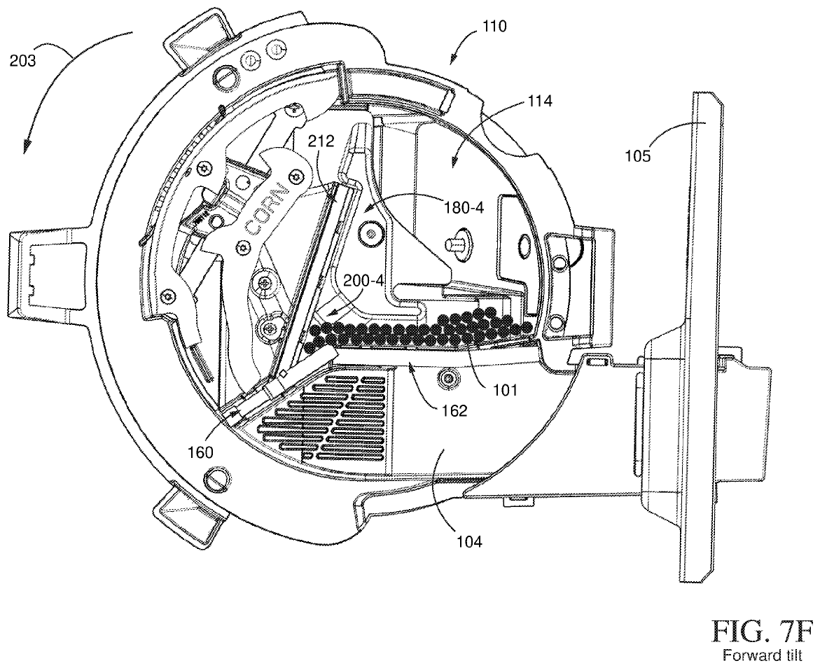

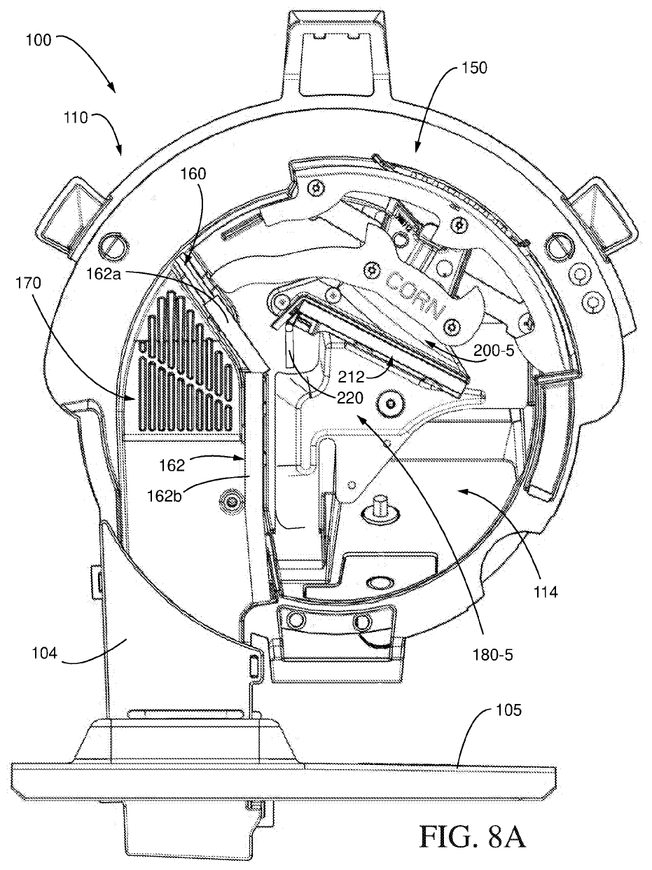

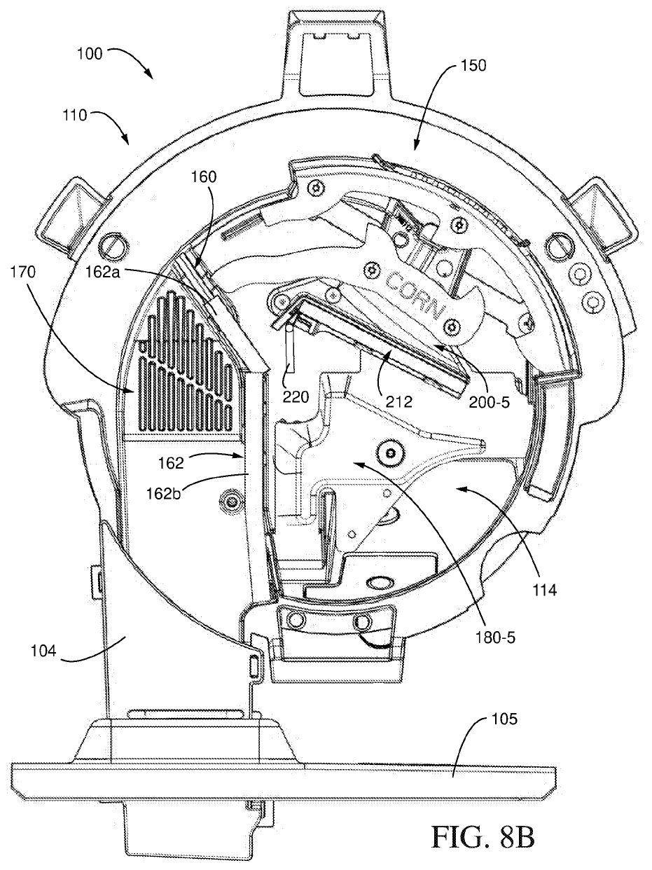

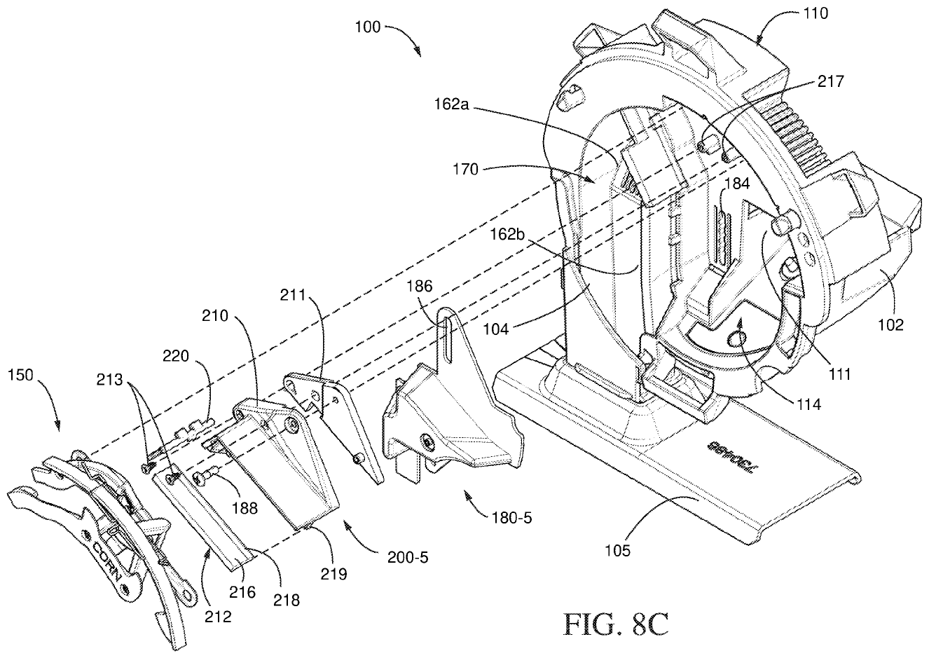

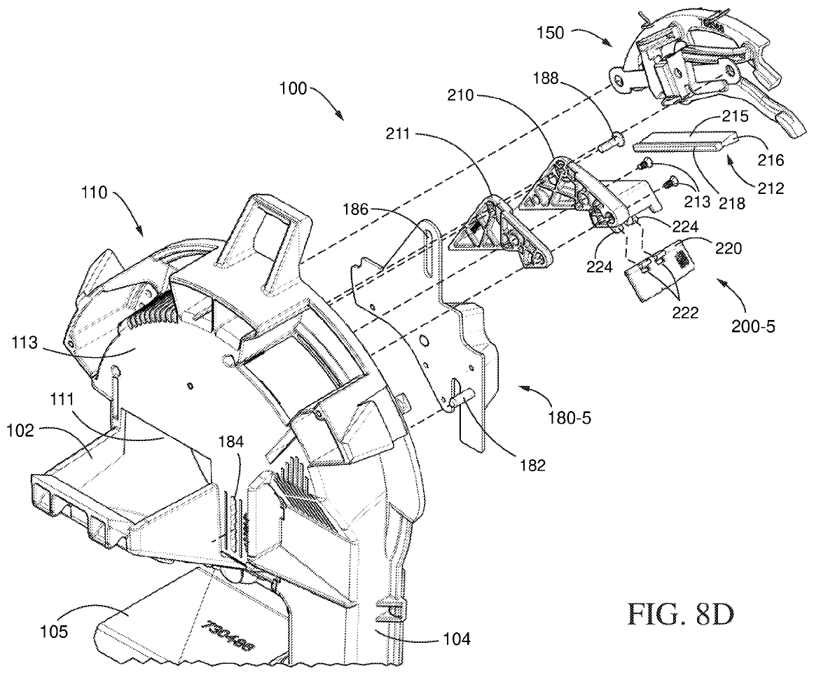

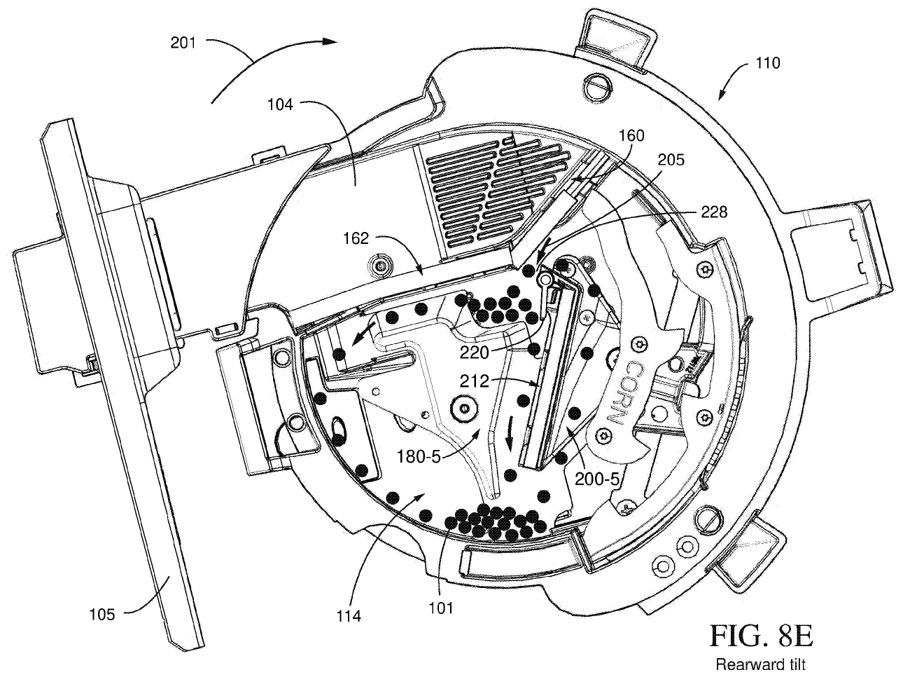

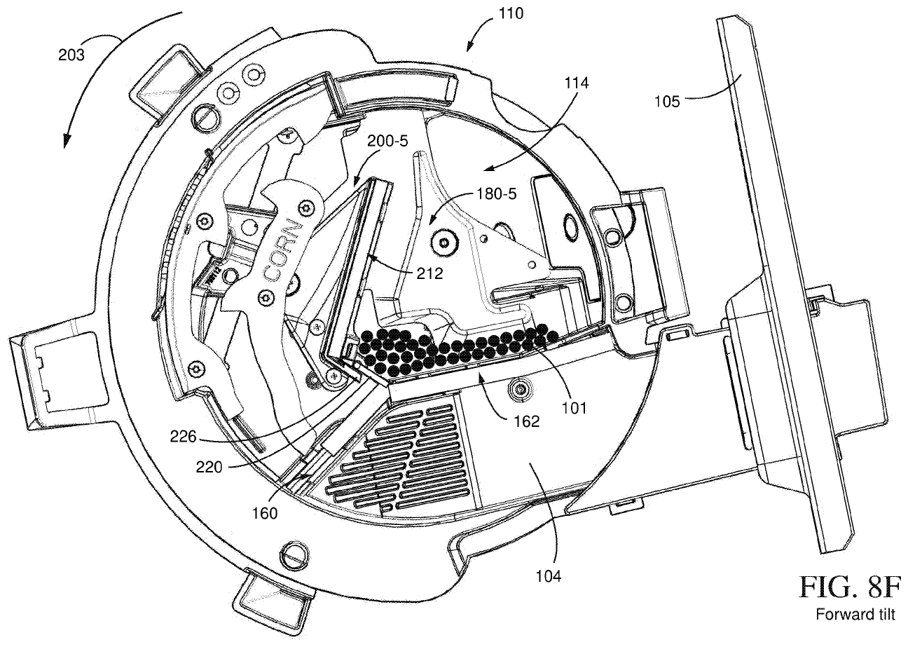

FIG. 1B is a right side elevation view of the existing planter row unit of FIG. 2A in the operating position.

FIG. 2C is a left side elevation view of the existing planter row unit of FIG. 2A showing the hopper and seed meter being removed from the row unit.

FIG. 3A is a left front perspective view of the existing seed meter shown in FIG. 1A.

FIG. 3B is an exploded left front perspective view of the existing seed meter shown in FIG. 1A.

FIG. 3C is an exploded right front perspective view of the existing seed meter shown in FIG. 1A.

FIG. 3D is left side elevation view of the existing seed meter shown in FIG. 3A, but with the right side cover and seed disk removed in order to show the internal structure of the seed meter on the seed-side of the disk and showing the baffle in the first position setting.

FIG. 3E is the same view of the existing seed meter as in FIG. 3D, but with the baffle in the fourth position setting.

FIG. 3F is a front perspective view of the seed meter housing showing the singulator and baffle member exploded from the housing.

FIG. 3G is a rear perspective view of the seed meter housing showing the singulator and baffle member exploded from the housing.

FIG. 3H is the same view of the existing seed meter as in FIG. 3E, but with the seed meter in the forward tilted position as represented in FIG. 1C and showing the flow of the seeds that remain in the seed meter when moved to such position.

FIG. 3G is the same view of the existing seed meter as in FIG. 3E, but with the seed meter in the forward tilted position and showing how the seeds remaining in the seed meter may flow and escape out of the seed meter when moved to such position.

FIG. 4A is left side elevation view of a seed meter substantially the same as shown in FIG. 3D, but including a first embodiment of a seed retaining structure, and showing the baffle member in the first position setting.

FIG. 4B shows the same view of the seed meter with the first embodiment of the seed retaining structure as in FIG. 4A, but with the baffle member in the fourth position setting.

FIG. 4C is an exploded front perspective view of the seed meter housing showing the singulator, the baffle member and the first embodiment of the seed retaining structure exploded from the housing.

FIG. 4D is an exploded rear perspective view of the seed meter housing showing the singulator, the baffle member and the first embodiment of the seed retaining structure exploded from the housing.

FIG. 4E illustrates the same seed meter and the first embodiment of the seed retaining structure as in FIG. 4B, but showing how the first embodiment of the seed retaining structure directs the seeds that remain in the seed meter when the seed meter is tilted in the rearward direction.

FIG. 4F illustrates the same seed meter and the first embodiment of the seed retaining structure as in FIG. 4B, but showing how the first embodiment of the seed retaining structure retains the seeds when the seed meter is tilted in the forward direction.

FIG. 5A is left side elevation view of a seed meter substantially the same as shown in FIG. 3D, but including a second embodiment of a seed retaining structure, and showing the baffle member in the first position setting.

FIG. 5B shows the same view of the seed meter with the second embodiment of the seed retaining structure as in FIG. 5A, but with the baffle member in the fourth position setting.

FIG. 5C is an exploded front perspective view of the seed meter housing showing the singulator, the baffle member and the second embodiment of the seed retaining structure exploded from the housing.

FIG. 5D is an exploded rear perspective view of the seed meter housing showing the singulator, the baffle member and the second embodiment of the seed retaining structure exploded from the housing.

FIG. 5E illustrates the same seed meter and the second embodiment of the seed retaining structure as in FIG. 5B, but showing how the second embodiment of the seed retaining structure directs the seeds that remain in the seed meter when the seed meter is tilted in the rearward direction.

FIG. 5F illustrates the same seed meter and the second embodiment of the seed retaining structure as in FIG. 5B, but showing how the second embodiment of the seed retaining structure retains the seeds when the seed meter is tilted in the forward direction.

FIG. 6A is left side elevation view of a seed meter substantially the same as shown in FIG. 3D, but including a third embodiment of a seed retaining structure, and showing the baffle member in the first position setting.

FIG. 6B shows the same view of the seed meter with the third embodiment of the seed retaining structure as in FIG. 6A, but with the baffle member in the fourth position setting.

FIG. 6C is an exploded front perspective view of the seed meter housing showing the singulator, the baffle member and the third embodiment of the seed retaining structure exploded from the housing.

FIG. 6D is an exploded rear perspective view of the seed meter housing showing the singulator, the baffle member and the third embodiment of the seed retaining structure exploded from the housing.

FIG. 6E illustrates the same seed meter and the third embodiment of the seed retaining structure as in FIG. 6B, but showing how the third embodiment of the seed retaining structure directs the seeds that remain in the seed meter when the seed meter is tilted in the rearward direction.

FIG. 6F illustrates the same seed meter and the third embodiment of the seed retaining structure as in FIG. 6B, but showing how the third embodiment of the seed retaining structure retains the seeds when the seed meter is tilted in the forward direction.

FIG. 7A is left side elevation view of a seed meter substantially the same as shown in FIG. 3D, but including a fourth embodiment of a seed retaining structure, and showing the baffle member in the first position setting.

FIG. 7B shows the same view of the seed meter with the fourth embodiment of the seed retaining structure as in FIG. 7A, but with the baffle member in the fourth position setting.

FIG. 7C is an exploded front perspective view of the seed meter housing showing the singulator, the baffle member and the fourth embodiment of the seed retaining structure exploded from the housing.

FIG. 7D is an exploded rear perspective view of the seed meter housing showing the singulator, the baffle member and the fourth embodiment of the seed retaining structure exploded from the housing.

FIG. 7E illustrates the same seed meter and the fourth embodiment of the seed retaining structure as in FIG. 7B, but showing how the fourth embodiment of the seed retaining structure directs the seeds that remain in the seed meter when the seed meter is tilted in the rearward direction.

FIG. 7F illustrates the same seed meter and the fourth embodiment of the seed retaining structure as in FIG. 7B, but showing how the fourth embodiment of the seed retaining structure retains the seeds when the seed meter is tilted in the forward direction.

FIG. 8A is left side elevation view of a seed meter substantially the same as shown in FIG. 3D, but including a fifth embodiment of a seed retaining structure, and showing the baffle member in the first position setting.

FIG. 8B shows the same view of the seed meter with the fourth embodiment of the seed retaining structure as in FIG. 8A, but with the baffle member in the fourth position setting.

FIG. 8C is an exploded front perspective view of the seed meter housing showing the singulator, the baffle member and the fourth embodiment of the seed retaining structure exploded from the housing.

FIG. 8D is an exploded rear perspective view of the seed meter housing showing the singulator, the baffle member and the fourth embodiment of the seed retaining structure exploded from the housing.

FIG. 8E illustrates the same seed meter and the fourth embodiment of the seed retaining structure as in FIG. 8B, but showing how the fourth embodiment of the seed retaining structure directs the seeds that remain in the seed meter when the seed meter is tilted in the rearward direction.

FIG. 8F illustrates the same seed meter and the fourth embodiment of the seed retaining structure as in FIG. 8B, but showing how the fourth embodiment of the seed retaining structure retains the seeds when the seed meter is tilted in the forward direction.

### DESCRIPTION

All references cited herein are incorporated herein in their entireties. If there is a conflict between definitions herein and in an incorporated reference, the definition herein shall control.

Referring to the drawings, wherein like reference numerals designate the same or corresponding parts throughout the several views, FIG. 1A shows a left side elevation view of a planter row unit 10 of an agricultural planter 11. FIG. 1B shows a right side elevation view of the planter row unit 10 of FIG. 1A. Although the row unit 10 is illustrated as the Ready Row Unit™ available from Precision Planting LLC, 23207 Townline Rd, Tremont, IL 61568 USA (“Precision Planting”), it should be appreciated that the row unit 10 may be any row unit available from an original equipment manufacturer or after-market provider. It should be understood that although only one planter row unit 10 is illustrated, the planter 11 will include a plurality of row units 10 laterally spaced along a toolbar 12.

Each row unit 10 may be supported from the toolbar 12 by a parallel arm linkage 14 which permits each row unit 10 to move vertically independently with respect to the toolbar 12. The row unit 10 includes a frame member 16. A forward end of the frame member 16 includes a downwardly extending shank 18 which supports a trench opening assembly 20. The rearward end of the frame member 16 supports a trench closing assembly 30. The frame member 16 also supports a seed hopper 40 and a seed meter 100 (discussed later). The seed hopper 40 may be a conventional or standard hopper as shown, or the hopper 40 may be a mini-hopper typically associated with a central-fill bulk hopper (not shown) disposed on the planter or on a seed cart as is well known in the art.

The trench opening assembly 20 may include a pair of opening discs 22 and a pair of gauge wheels 24. The opening discs 22 may be rotatably mounted to the downwardly extending shank 18 and angled outwardly and rearwardly to cut a v-shaped seed trench 25 in the soil surface as the row unit 10 travels in a forward direction of travel as indicated by arrow 1. Each of the pair of gauge wheels 24 may be rotatably mounted at one end of a respective gauge wheel arm 26. The other end of the respective gauge wheel arms 26 may be pivotally mounted to the frame member 16. The row unit 10 may include a depth adjustment mechanism 60 to selectively set a position of a rocker (not shown) to abut the gauge wheel arms 26 limiting the upward pivotal displacement of the gauge wheels 24 relative to the bottom of the opening discs 22, thereby setting the depth of penetration of the opening discs 22 into the soil surface and thus the depth of the seed trench 25. In some embodiments, the trench opening assembly 20 may utilize a single opening disc to cut the seed trench and a single gauge wheel for regulating the depth of the seed trench as is well known in the art. A supplemental downforce system 70, such as the DeltaForce™ system available from Precision Planting, may be utilized to apply a controlled downforce and optionally a controlled upforce on the row unit 10 such that full desired trench depth set by the depth adjustment mechanism 60 is maintained in varying soil conditions. The supplemental downforce system 70 may include downforce actuator 72 mounted at one end to the toolbar 12 and coupled at the other end to the parallel arm linkage 14. In operation, the extension of the hydraulic cylinder 72 will exert a supplemental downforce on the parallel arm linkage 14, thus increasing the downforce on the row unit 10. Likewise, if the hydraulic cylinder 72 is retracted an upforce will be applied on the parallel arm linkage 14, and thus decreasing the downforce force acting on the row unit 10.

Seeds 101 are communicated from the seed hopper 40 to the seed meter 100 via a seed inlet chute 102 (FIG. 1B). The seed meter 100 singulates the seeds and discharges the singulated seeds 101 through a seed exit chute 104. The seed meter 100 may be any commercially available seed meter. In the row unit shown in FIGS. 1A-1C, the seed meter 100 may include a vacuum tube 106 that connects with a vacuum tube coupler 107 at a forward end of the row unit 10. The vacuum tube coupler 107 is in communication with a vacuum tube (not shown) in communication with a vacuum source (not shown) which may be supported on the planter 11, on a tractor (not shown) pulling the planter 11 or on a seed cart (not shown) coupled with the planter 11. The seed exit chute 104 may connect to a seed tube 50 which directs the singulated seeds discharged by the seed meter 100 downwardly and rearwardly into the seed trench 25. In an alternative embodiment as shown in FIGS. 2A-2B, rather than the seed meter 100 discharging the seeds into a seed tube 50, the seed meter 100 may discharge the seeds into a seed conveyor 51 for controlled delivery of the seeds 101 to the seed trench 25. The seed conveyor 51 may include a flighted belt driven by an electric drive motor 53, such as the SpeedTube® available from Precision Planting, or the ExactEmerge® brush belt available from Deere & Co., or the SureSpeed™ conveyor available from Kinze Manufacturing, Inc. or AgLeader Technology, Inc., or any other commercially available seed conveyor system.

The closing assembly 30 may include a closing wheel arm 32 that is pivotally attached at its forward end to the rearward end of the frame member 16. A pair of closing wheels 34 may be rotatably supported at the rearward end of the closing wheel arm 32. The closing wheels 34 may be positioned on each side of the open seed trench 25 cut by the opening discs 22 and may be oriented to diverge upwardly and outwardly with respect to the lower rearward portion of the closing wheels 34 to funnel the soil inwardly toward the open seed trench 25 thereby covering the seed 101 and closing the seed trench 25. A spring or downforce actuator (not shown) may apply a down-pressure to cause the closing wheels 34 to compact the soil over the deposited seed to ensure good seed-to-soil contact.

FIG. 1C illustrates one example of the hopper 40 and seed meter 100 of the row unit 10 being removed or installed on the frame member 16. FIG. 2C is similar to FIG. 1C, but shows the embodiment of the hopper 40 and seed meter 100 disengaging from the seed conveyor 51 and the vacuum tube coupler 107. In either embodiment, the seed meter 100 and hopper 40 are able to tilt rearwardly as a unit to disengaging from the seed tube 50 or seed conveyor 51 and the vacuum tube coupler 107. The rearwardly tilted meter and hopper unit may then be removed from the frame member 16 together or the seed meter 100 may be removed separately from the tilted hopper 40. In other embodiments, rather than tilting rearwardly, the hopper 40 and seed meter 100 may be tilted together forwardly (not shown) and removed from the frame member 16. In still other embodiments, the hopper 40 and meter 100 may be lifted together as a unit vertically from the frame member 16. In yet another embodiment, the hopper 40 may be removed from the frame member 16 separately from the seed meter 100.

FIGS. 3A-3D illustrate one embodiment of a commercially available vacuum seed meter 100 such as the V-Set® seed meter available from Precision Planting LLC. It should be appreciated that the seed meter 100 shown in FIGS. 3A-3D corresponds to the embodiment of the seed meter shown in FIGS. 1A-1C with the seed hopper 40 and vacuum tube 106 removed. As best illustrated in the exploded views of FIGS. 3B and 3C, the vacuum seed meter 100 may include a housing 110 and a removable cover 112 which together form an enclosure around a rotatable seed disc 130. The side of the seed disc 130 facing the cover 112 is hereinafter referred to as the vacuum-side of the seed disc 130. The side of the seed disc 130 facing the housing 110 is hereinafter referred to as the seed-side of the disc 130.

Referring to FIG. 3C, the housing 110 includes the seed inlet chute 102 through which the seeds pass from the hopper 40 into the housing 110 via an opening 111 in the back wall 113 of the housing 110. The inside lower right quadrant of the housing 110 (from about the 3 o'clock to about the 6 o'clock position as best viewed in FIG. 3B) is sloped and defines a seed pool area 114. The housing 110 also includes the seed exit chute 104 through which the singulated seeds are discharged before passing into the seed tube 50. The lower end of the seed exit chute 104 may include a boot 105 that covers the opening in the frame member 16 around the seed tube 50.

Referring to FIG. 2C, it should be appreciated that if the seed meter 100 is used with a seed conveyor 51, the lower portion of the seed exit chute 104 is removed from the housing 110 such that the seed conveyor 51 is able to receive the seed directly from the seed disc 130. In embodiments with the seed conveyor 51, the boot 105 remains on the frame member 16 surrounding the seed conveyor 51 where it passes through the frame member 16.

The removable cover 112 includes a vacuum port 116 to which the vacuum tube 106 (FIG. 1A) couples. As best viewed in FIG. 3C, the inside of the cover 112 includes a gasket 118 that surrounds the vacuum port 116 and extends approximately around three-fourths of the inside surface of the cover 112 in a clockwise direction (as viewed in FIG. 3C) from about the 6′oclock position to about the 3 o'clock position defining a vacuum area 120. The gasket 118 seals against the outside surface of the seed disc 130. A spindle 122 projects inwardly from the cover 112 toward the housing 110. A central plate 124 is rotatable about the spindle 122 and includes two inwardly projecting pegs 125. The seed disc 130 includes a central opening 132 and two spaced holes 134. The central opening 132 receives the spindle 122. The two spaced holes 134 matingly align with and receive the pegs 125. The spindle 122 includes a transverse bore 126 to receive a retaining clip 128 that holds the seed disc 130 on the spindle 122 and the pegs 125 in engagement with the spaced holes 134 such that the seed disc 130 rotates with the rotatable central plate 124 about the spindle 122. The cover 112 may also include an ejector wheel 129 that engages with the seed disc 130 to push out any seeds, partial seeds or debris trapped in the seed apertures 136 from the vacuum-side of the seed disc 130. Referring to FIG. 2B, it should be appreciated that if the seed meter 100 is used with a seed conveyor 51, a portion of the front cover 112 is removed to accommodate the seed conveyor 51 so the seed conveyor 51 is able to receive the seed directly from the seed disc 120.

The seed disc 130 includes a plurality of radially spaced apertures 136 and a plurality of circumferential teeth 138. As best viewed in FIG. 3B, the circumferential teeth 138 matingly engage with teeth of a drive sprocket 140 of a variable speed electric drive motor 142 which drives rotation of the seed disc 130 about the spindle in the direction indicated by arrow 131.

In operation, as the seed disc 130 rotates, the apertures 136 rotate past the gasket 118 on the vacuum-side of the seed disc 130 and into the vacuum area 120. On the seed-side of the seed disc 130, the apertures 136 enter the seed pool area 114. Due to the vacuum on the vacuum-side of the seed disc 130, the seeds 101 in the seed pool area 114 are drawn toward the apertures 136 by the suction force through the apertures 136 resulting in one or more seeds being entrained over each aperture 136 on the seed-side of the seed disc 130. As the seed disc 130 continues to rotate in the counterclockwise direction as viewed in FIG. 3B, the entrained seeds 101 on the seed-side of the seed disc 130 engage with a seed singulator 150 configured to strip any seed multiples that may be entrained over a seed aperture 136, such that after the seeds rotate by the seed singulator 150, each seed aperture 136 ideally carries only one entrained seed. As best illustrated in FIG. 3D, the seed singulator 150, may include an upper singulating member 150a and a lower singulating member 150b having one or more lobes 152 positioned to bump and orient the entrained seeds. The singulating members 150a, 150b may be being axially, radially and rotationally biased. In alternative embodiments, the singulator 150 may comprise one or more brushes that engage with the entrained seeds to strip any seed multiples from the apertures.

Referring to FIGS. 3B and 3D, as the seed disc 130 continues to rotate in the counterclockwise direction as viewed in FIG. 3B, the singulated seeds rotate through a gap 160 above a generally vertical brush 162 on the seed side of the seed disc 130. The generally vertical brush 162 defines an inside wall of the seed exit chute 104 and separates the seed exit chute 104 from the seed pool area 114. The generally vertical brush 162 may include an upper brush portion 162a and a lower brush portion 162b. The upper brush portion 162a may be angled downwardly and inwardly from the gap 160 to direct any seeds stripped by the seed singulator 150 back toward the seed pool area 114. Once the entrained seeds 101 pass through the gap 160 on the seed-side of the seed disc 130, the singulated seeds rotate past the gasket 118 and beyond the vacuum area 120 on the vacuum-side of the seed disc 130. Thus, it should be appreciated that at this point there is no longer any vacuum applied to the apertures 136, such that the seeds 101 fall by gravity from the seed-side of the seed disc 130 into the seed exit chute 104. The back wall 113 of the housing 110 at the upper end of the seed chute 104 may include a vent area 170 open to atmosphere to facilitate the release of the seeds from the seed-side of the seed disk 130.

The housing 110 may include a baffle member 180 movable between selectable settings to regulate the amount of seed flowing into the housing 110 through the opening 111 in the back wall 113 of the housing 110. FIGS. 3F and 3G are front and rear perspective views, respectively, showing the seed singulator 150 and the baffle member 180 exploded from housing 110. As best illustrated in FIG. 3G, the rearward side of the baffle member 180 includes a lever 182 that extends through a slot 184 in the back wall 113 of the housing 110. As best illustrated in FIGS. 3C and 3G, the lever 182 serves as a handle to move the baffle member 180 between selectable settings 1-4. The baffle member 180 is slidably disposed in the housing via a vertically slotted arm 186 that slides along a threaded connector 188 that is threadably received in the back wall 113 of the housing 110. FIG. 3D shows the baffle member 180 in the lowermost position (setting 1). FIG. 3E shows the baffle member 180 in the uppermost position (setting 4).

FIGS. 3H and 3I are example illustrations showing how the seeds that are still held within the seed meter 100 after planting operations are able to move within the seed meter 100 on the seed-side of the seed disc 130 when the seed meter 100 is tilted in the rearward direction or forward direction during removal from the row unit 10 or during folding operations or transportation. As sown in FIG. 3H, when the seed meter 100 is tilted in the rearward direction as indicated by arrow 190 (such as shown in FIG. 1C), the seeds 101 flow away from the seed exit chute 104 and around the baffle member 180 as indicated by arrow 191 and return to the seed pool area 114. As shown in FIG. 3I, when the seed meter is tilted in for forward direction as indicated by arrow 192, the seeds 101 may flow between the generally vertical brush 160 and the baffle member 180 toward the seed exit chute 104 and may flow out of the seed meter 100 as indicated by arrow 193 because there is no internal structure to retain the seeds inside the seed meter 100 when in this position.

To avoid the undesirable occurrence of seed falling out of the seed exit chute 104 when the seed meter 100 is tilted forwardly, and to ensure the seed is returned to the seed pool area 114 when the seed meter 100 is tilted rearwardly, a seed retaining structure 200 may be incorporated into the seed meter 100 as hereinafter described.

FIGS. 4A-4F show a first embodiment of the seed retaining structure 200-1 incorporated into the housing 110 of a seed meter 100. It should be appreciated that all other structural features and functionalities of the seed meter 100 may be the same as described above in connection with FIGS. 3A-3G so their descriptions will not be repeated here. To accommodate the first embodiment of the seed retaining structure 200-1, the baffle member 180 as previously described may be modified as best illustrated in FIGS. 4C and 4D. In this embodiment, the modified baffle member is designated generally by reference number 180-1. As in the embodiment of FIGS. 3A-3G, the baffle member 180-1 may be movable between position settings 1-4 via lever 182 extending through the slot 184 in the back wall 113 of the housing 110 to regulate the amount of seeds 101 entering into the seed pool area 114 through the opening 111. FIG. 4A shows the baffle member 180-1 in the lowermost setting (setting 1). FIG. 4B shows the baffle member 180-1 in the uppermost setting (setting 4).

As best illustrated in the exploded views of FIGS. 4C and 4D, the first embodiment of the seed retaining structure 200-1 includes a body 210 which supports a transverse brush 212 and a swingable flap 220. The transverse brush 212 may have a first end proximate the generally vertical brush 162. The transverse brush 212 may extend generally transversely across a substantial portion of the diameter of the housing 110, terminating at a second end. The transverse brush 212 may include a first brush portion 212a and a second brush portion 212b disposed at an angle with respect to one another forming an upward apex 215. The first brush portion 212a may slope downwardly from the apex 215 toward the generally vertical brush 162. The second brush portion 212b may slope downwardly from the apex 215 to the second end toward the seed pool area 114. The first and second brush portions 212a, 212b may be comprised of flexible bristles 216 extending from a block member 218. The body 210 may include tabs 219 that engage with the block members 218 for securing the first and second brush portions 212a, 212b to the body 210. The body 210 may secure to the back wall 113 of the housing 110 by threaded connectors 213 received within projecting posts 217. A threaded connector 188 extends through the slot 186 of the baffle member 180-1 to slidably secure the baffle member 180-1 to the back wall of the housing 110 as described in connection with FIGS. 3A-3G. The threaded connector 188 may also extend through the body 210.

As best illustrated in FIG. 4D, the swingable flap 220 may include a slot 222 that is received by hooks 224 on the body 210. The slot 222 and hooks 224 are configured to allow the swingable flap 220 to swing freely upon the hooks 224 between an open position and a closed position. It should be appreciated that because the swingable flap 220 is able to swing freely upon the hooks 224, its center of gravity will cause the free end of the flap (i.e., the end opposite the slot 22) to point toward the earth such that the flap will remain substantially vertical when the seed meter 100 is in the operating position. Likewise when the seed meter is tilted rearwardly (i.e., clockwise as indicated by arrow 201 as viewed in FIG. 4E), the flap 220 will remain substantially vertical until the flap abuts an obstruction preventing it from swinging further counterclockwise relative to the clockwise rotation of the housing 110. Similarly, when the seed meter is tilted forwardly (i.e., counterclockwise as indicated by arrow 203 as viewed in FIG. 4F), the flap 220 will remain substantially vertical until the flap 220 abuts a flap stop 226 (FIGS. 4C and 4F) preventing it from swinging further clockwise relative to the counterclockwise rotation of the housing 110. While the flap 220 is in the substantially vertical position, a passage 228 (FIG. 4E) remains open through which seeds 101 are able to pass as indicated by arrow 205 in FIG. 4E. It should be noted that the first brush portion 212a is represented in dashed lines to show the open passage 228 which would otherwise be hidden behind the first brush portion 212a. Thus, when the seed meter 100 is in the normal operating position as shown in FIGS. 4A and 4B, any seeds that are stripped from the seed disc 130 by the seed singulator 150 will be directed by the first brush portion 212a through the passage 228 and into the seed pool area 214 or will be directed downwardly and rearwardly by the second brush portion 212b to the seed pool area 114. Likewise, when the seed meter is in the rearward tilted position as shown in FIG. 4E, any seeds that remain above the transverse brush 212 will either pass through the passage 228 or will be directed by the transverse brush 212 to the seed pool area 114. As shown in FIG. 4F, when the seed meter 100 is tilted or rotated sufficiently in the forward direction such that the flap 220 abuts the flap stop 226, the passage 228 will be closed by the swingable flap 220, thereby retaining the seeds behind the seed retaining structure 200-1 and preventing the seeds from inadvertently flowing out of the seed exit chute 104. It should be noted that in FIG. 4F the first brush portion 212a is represented in dashed lines to show the passage 228 as being closed by the flap 220 which would otherwise be hidden behind the first transvers brush portion 212a.

FIGS. 5A-5F show a second embodiment of the seed retaining structure 200-2 incorporated into the housing 110 of a seed meter 100. It should be appreciated that all other structural features and functionalities of the seed meter 100 may be the same as described above in connection with FIGS. 3A-3G so their descriptions will not be repeated here. To accommodate the second embodiment of the seed retaining structure 200-2, the baffle member 180 as previously described may be modified as best illustrated in FIGS. 5C and 5D. In this embodiment, the modified baffle member is designated generally by reference number 180-2. As in the embodiment of FIGS. 3A-3G, the baffle member 180-2 may be movable between position settings 1-4 via lever 182 extending through the slot 184 in the back wall 113 of the housing 110 to regulate the amount of seeds 101 entering into the seed pool area 114 through the opening 111. FIG. 5A shows the baffle member 180-2 in the lowermost setting (setting 1). FIG. 5B shows the baffle member 180-2 in the uppermost setting (setting 4).

The second embodiment of the seed retaining structure 200-2 includes a transverse brush 212 and a swingable flap 220. The transverse brush 212 may have a first end proximate the generally vertical brush 162. The transverse brush 212 may extend generally transversely across a substantial portion of the diameter of the housing 110, terminating at a second end. The transverse brush 212 may include a first brush portion 212a and a second brush portion 212b disposed at an angle with respect to one another forming an upward apex 215. The first brush portion 212a may slope downwardly from the apex 215 toward the generally vertical brush 162. The second brush portion 212b may slope downwardly from the apex 215 to the second end toward the seed pool area 114. The first and second brush portions 212a, 212b may be comprised of flexible bristles 216 extending from a block member 218. The baffle member 180-2 may include tabs 219 that engage with the block members 218 to secure the first and second brush portions 212a, 212b to the baffle member. Thus, it should be appreciated that in this embodiment, the seed retainer structure 200-2 moves with the baffle member 180-2. A threaded connector 188 extends through the slot 186 of the baffle member 180-2 to slidably secure the baffle member 180-2 to the back wall of the housing 110 as describe in connection with FIGS. 3A-3G.

As best illustrated in FIG. 5D, the swingable flap 220 has a bushing 230 fixed at its upper end. The bushing 230 is received between spaced ears 232 extending from the baffle member 180-2. A pin 234 extends through holes 236 in the ears 232 and is received by the bushing 230. The flap 220 together with the bushing 230 is able to swing freely about the pin 234 between an open position and a closed position. It should be appreciated that because the swingable flap 220 is able to swing freely about the pin 234, its center of gravity will cause the free end of the flap (i.e., the end opposite the bushing 230) to point toward the earth such that the flap will remain substantially vertical when the seed meter 100 is in the operating position. Likewise, when the seed meter is tilted rearwardly (i.e., clockwise as indicated by arrow 201 as viewed in FIG. 5E), the flap 220 will remain substantially vertical until the flap abuts an obstruction (e.g., the baffle member 180-2) preventing it from swinging further counterclockwise relative to the clockwise rotation of the housing 110. Similarly, when the seed meter 100 is tilted forwardly (i.e., counterclockwise as indicated by arrow 203 as viewed in FIG. 5F), the flap 220 will remain substantially vertical until the flap 220 abuts a flap stop 226 (FIGS. 5C and 5F) preventing it from swinging further clockwise relative to the counterclockwise rotation of the housing 110. While the flap 220 is in the substantially vertical position, a passage 228 (FIG. 5E) remains open through which seeds 101 are able to pass as indicated by arrow 205 in FIG. 5E. Thus, when the seed meter 100 is in the normal operating position as shown in FIGS. 5A and 5B, any seeds that are stripped from the seed disc 130 by the seed singulator 150 will be directed by the first brush portion 212a through the passage 228 and into the seed pool area 214 or will be directed downwardly and rearwardly by the second brush portion 212b to the seed pool area 114. Likewise, when the seed meter is in the rearward tilted position as shown in FIG. 5E, any seeds that remain above the transverse brush 212 will either pass through the passage 228 or will be directed by the transverse brush 212 to the seed pool area 114. As shown in FIG. 5F, when the seed meter 100 is tilted or rotated sufficiently in the forward direction such that the flap 220 abuts the flap stop 226, the passage 228 will be closed by the flap 220, thereby retaining the seeds behind the seed retaining structure 200-2 and preventing the seeds from inadvertently flowing out of the seed exit chute 104.

FIGS. 6A-6F show a third embodiment of the seed retaining structure 200-3 incorporated into the housing 110 of a seed meter 100. It should be appreciated that all other structural features and functionalities of the seed meter 100 may be the same as described above in connection with FIGS. 3A-3G so their descriptions will not be repeated here. To accommodate the third embodiment of the seed retaining structure 200-3, the baffle member 180 as previously described may be modified as best illustrated in FIGS. 6C and 6D. In this embodiment, the modified baffle member is designated generally by reference number 180-3. As in the embodiment of FIGS. 3A-3G, the baffle member 180-3 may be movable between position settings 1-4 via lever 182 extending through the slot 184 in the back wall 113 of the housing 110 to regulate the amount of seeds 101 entering into the seed pool area 114 through the opening 111. FIG. 6A shows the baffle member 180-3 in the lowermost setting (setting 1). FIG. 6B shows the baffle member 180-3 in the uppermost setting (setting 4).

The third embodiment of the seed retaining structure 200-3 includes a body 210 which supports a first transverse brush 212a and a swingable flap 220. The first transverse brush 212a may slope downwardly from an upper end toward the generally vertical brush 162. A second transverse brush 212b may mount to the baffle member 180-3 and may slope from a first end upwardly toward a second end. The first and second transverse brushes 212a, 212b may be comprised of flexible bristles 216 extending from a block member 218. The body 210 may include tabs 219 that engage with the block member 218 of the first transverse brush 212 to secure the first transverse brush 212a to the body 210. Similarly, the baffle member 180-3 may include tabs 219 to secure the second transverse brush 212b, to the baffle member 180-3. Thus, it should be appreciated that in this embodiment, the second transverse brush 212b moves with the baffle member 180-3. The body 210 may secure to the back wall 113 of the housing 110 by threaded connectors 213 received within projecting posts 217. A threaded connector 188 extends through the slot 186 of the baffle member 180-3 to slidably secure the baffle member 180-3 to the back wall of the housing 110 as describe in connection with FIGS. 3A-3G.

As best illustrated in FIG. 6D, the swingable flap 220 may include a slot 222 that is received by hooks 224 on the body 210. The slot 222 and hooks 224 are configured to allow the swingable flap 220 to swing freely upon the hooks 224 between an open position and a closed position. It should be appreciated that because the swingable flap 220 is able to swing freely upon the hooks 224, its center of gravity will cause the free end of the flap (i.e., the end opposite the slot 222) to point toward the earth such that the flap will remain substantially vertical when the seed meter 100 is in the operating position. Likewise when the seed meter is tilted rearwardly (i.e., clockwise as indicated by arrow 201 as viewed in FIG. 6E), the flap 220 will remain substantially vertical until the flap abuts an obstruction preventing it from swinging further counterclockwise relative to the clockwise rotation of the housing 110. Similarly, when the seed meter 100 is tilted forwardly (i.e., counterclockwise as indicated by arrow 203 as viewed in FIG. 6F), the flap 220 will remain substantially vertical until the flap 220 abuts a flap stop 226 (FIGS. 6C and 6F) preventing it from swinging further clockwise relative to the counterclockwise rotation of the housing 110. While the flap 220 is in the substantially vertical position, a passage 228 (FIG. 6E) remains open through which seeds 101 are able to pass as indicated by arrow 205 in FIG. 6E. Thus, when the seed meter 100 is in the normal operating position as shown in FIGS. 6A and 6B, any seeds that are stripped from the seed disc 130 by the seed singulator 150 will be directed by the first transverse brush 212 through the passage 228 and into the seed pool area 214 or will be directed downwardly and rearwardly by the second transverse brush 213 to the seed pool area 114. Likewise, when the seed meter is in the rearward tilted position as shown in FIG. 6E, any seeds that remain above the first transverse brush 212 will either pass through the passage 228 or will be directed by the first and second transverse brushes 212, 213 downwardly and rearwardly to the seed pool area 114. As shown in FIG. 6F, when the seed meter 100 is tilted or rotated sufficiently in the forward direction such that the flap 220 abuts the flap stop 226, the passage 228 will be closed by the flap 220, thereby retaining the seeds behind the seed retaining structure 200-3 and preventing the seeds from inadvertently flowing out of the seed exit chute 104.

FIGS. 7A-7F show a fourth embodiment of the seed retaining structure 200-4 incorporated into the housing 110 of a seed meter 100. It should be appreciated that all other structural features and functionalities of the seed meter 100 may be the same as described above in connection with FIGS. 3A-3G so their descriptions will not be repeated here. To accommodate the fourth embodiment of the seed retaining structure 200-4, the baffle member 180 as previously described may be modified as best illustrated in FIGS. 7C and 7D. In this embodiment, the modified baffle member is designated generally by reference number 180-4. As in the embodiment of FIGS. 3A-3G, the baffle member 180-4 may be movable between position settings 1-4 via lever 182 extending through the slot 184 in the back wall 113 of the housing 110 to regulate the amount of seeds 101 entering into the seed pool area 114 through the opening 111. FIG. 7A shows the baffle member 180-4 in the lowermost setting (setting 1). FIG. 7B shows the baffle member 180-4 in the uppermost setting (setting 4).

The fourth embodiment of the seed retaining structure 200-4 includes a body 210 which supports a transverse brush 212. A first end of the transverse brush 212 begins proximate the generally vertical brush 162 and extends generally transversely across a substantial portion of the diameter of the housing 110 to a second end. The transverse brush 212 may slope downwardly from the first end to the second end. The transverse brush 212 may be comprised of flexible bristles 216 extending from a block member 218. The body 210 may include tabs 219 that engage with the block member 218 of the transverse brush 212 to secure the transverse brush 212 to the body 210. The body 210 may secure to the back wall 113 of the housing by threaded connectors 213 received within projecting posts 217. A threaded connector 188 extends through the slot 186 of the baffle member 180-4 to slidably secure the baffle member 180-4 to the back wall of the housing 110 as describe in connection with FIGS. 3A-3G. The threaded connector 188 may also extend through the body 210.

When the seed meter 100 is in the normal operating position as shown in FIGS. 7A and 7B, any seeds that are stripped from the seed disc 130 by the seed singulator 150 will be directed by the transverse brush 212 to the seed pool area 114. Likewise as shown in FIG. 7E, when the seed meter is tilted rearwardly (i.e., clockwise as indicated by arrow 201 as viewed in FIG. 7E), the transverse brush 212 will direct any seeds that may remain in the seed meter 100 toward the seed pool area 114. As shown in FIG. 7F, when the seed meter 100 is tilted forwardly (i.e., counterclockwise as indicated by arrow 203 as viewed in FIG. 7F), the transverse brush 212 will retain any seeds in the seed pool area 114 preventing the seeds from inadvertently flowing out of the seed exit chute 104.

FIGS. 8A-8F show a fifth embodiment of the seed retaining structure 200-5 incorporated into the housing 110 of a seed meter 100. It should be appreciated that all other structural features and functionalities of the seed meter 100 may be the same as described above in connection with FIGS. 3A-3G so their descriptions will not be repeated here. To accommodate the fifth embodiment of the seed retaining structure 200-5, the baffle member 180 as previously described may be modified as best illustrated in FIGS. 8C and 8D. In this embodiment, the modified baffle member is designated generally by reference number 180-5. As in the embodiment of FIGS. 3A-3G, the baffle member 180-5 may be movable between position settings 1-4 via lever 182 extending through the slot 184 in the back wall 113 of the housing 110 to regulate the amount of seeds 101 entering into the seed pool area 114 through the opening 111. FIG. 8A shows the baffle member 180-5 in the lowermost setting (setting 1). FIG. 8B shows the baffle member 180-5 in the uppermost setting (setting 4).

The fifth embodiment of the seed retaining structure 200-5 includes a body 210 which supports a transverse brush 212 and a swingable flap 220. As best viewed in the exploded views of FIGS. 8C and 8D, an optional spacer 211 may be provided between the retaining structure 200-5 and the baffle member 180-5 in order to increase the distance (if needed) by which the transverse brush 212 extends toward the seed-side face of the seed disc 130. As best viewed in FIGS. 8A and 8B, a first end of the transverse brush 212 begins proximate the generally vertical brush 162 and extends generally transversely across a substantial portion of the diameter of the housing 110 to a second end. The transverse brush 212 may slope downwardly from the first end to the second end. The transverse brush 212 may be comprised of flexible bristles 216 extending from a block member 218. The body 210 may include tabs 219 (FIG. 8C) that engage with the block member 218 of the transverse brush 212 to secure the transverse brush 212 to the body 210. The body 210 may secure to the back wall 113 of the housing by threaded connectors 213 received within projecting posts 217. A threaded connector 188 extends through the slot 186 of the baffle member 180-5 to slidably secure the baffle member 180-5 to the back wall of the housing 110 as describe in connection with FIGS. 3A-3G. The threaded connector 188 may also extend through an aperture in the body 210.

As best illustrated in FIG. 8D, the swingable flap 220 may include slots 222 that are received by hooks 224 on the body 210. The slot 222 and hooks 224 are configured to allow the swingable flap 220 to swing freely upon the hooks 224 between an open position and a closed position. It should be appreciated that because the swingable flap 220 is able to swing freely upon the hooks 224, its center of gravity will cause the free end of the flap (i.e., the end opposite the slot 222) to point toward the earth such that the flap will remain substantially vertical when the seed meter 100 is in the operating position. Likewise when the seed meter is tilted rearwardly (i.e., clockwise as indicated by arrow 201 as viewed in FIG. 8E), the flap 220 will remain substantially vertical until the flap abuts an obstruction preventing it from swinging further counterclockwise relative to the clockwise rotation of the housing 110. Similarly, when the seed meter 100 is tilted forwardly (i.e., counterclockwise as indicated by arrow 203 as viewed in FIG. 8F), the flap 220 will remain substantially vertical until the flap 220 abuts a flap stop 226 (FIG. 8F) preventing it from swinging further clockwise relative to the counterclockwise rotation of the housing 110. In this embodiment the stop 226 is an extension of the seed retaining structure 200-5. While the flap 220 is in the substantially vertical position, a passage 228 (FIG. 8E) remains open through which seeds 101 are able to pass as indicated by arrow 205 in FIG. 8E. Thus, when the seed meter 100 is in the normal operating position as shown in FIGS. 8A and 8B, any seeds that are stripped from the seed disc 130 by the seed singulator 150 will be directed by the first transverse brush 212 through the passage 228 and into the seed pool area 214 or will be directed downwardly and rearwardly by the transverse brush 212 to the seed pool area 114. Likewise, when the seed meter is in the rearward tilted position as shown in FIG. 8E, any seeds that remain above the first transverse brush 212 will either pass through the passage 228 or will be directed by the transverse brushes 212 downwardly and rearwardly to the seed pool area 114. As shown in FIG. 8F, when the seed meter 100 is tilted or rotated sufficiently in the forward direction such that the flap 220 abuts the flap stop 226, the passage 228 will be closed by the flap 220, thereby retaining the seeds behind the seed retaining structure 200-5 and preventing the seeds from inadvertently flowing out of the seed exit chute 104.

It should be appreciated that although the seed meter 100 is shown and described as being a modified V-Set meter available from Precision Planting, any of the embodiments of the seed retaining structure 200-1, 200-2, 200-3, 200-4 and 200-5 may be adapted for use with any type of vacuum seed meter.

### EXAMPLES

The following are non-limiting examples.

Example 1—a seed meter, comprising: a housing defining a seed inlet chute, a seed exit chute and a seed pool area, the seed inlet chute adapted to receive seed from a seed supply, the housing having an opening through which the seed passes from the seed inlet chute to the seed pool area; a cover removably attached to the housing, the cover including a vacuum port adapted to be in communication with a vacuum source; a seed disc rotatably disposed between the housing and the cover, the seed disc having a seed-side toward the housing and a vacuum-side toward the cover, the seed disc having a plurality of apertures adapted to carry the seeds from the seed pool area to the seed exit chute as the seed disc rotates when a vacuum is applied on the vacuum-side of the seed disc by the vacuum source via the vacuum port; a generally vertical brush disposed on the seed-side of the seed disc within the housing, the generally vertical brush separating the seed exit chute from the seed pool area; a seed retaining structure disposed on the seed-side of the seed disc within the housing, the seed retaining structure disposed to prevent the seed within the seed pool area from passing over the generally vertical brush from the seed pool area into the seed exit chute.

Example 2—the seed meter of Example 1, wherein the seed retaining structure includes a brush disposed generally transverse to the generally vertical brush.

Example 3—the seed meter of Example 2, wherein the seed retaining structure defines a seed passage adjacent to the generally vertical brush, the seed retaining structure further including a flap, the flap disposed to swing by force of gravity between a generally vertical open position and a closed position, wherein in the closed position, the seed passage is closed by the flap preventing the seed from passing through the seed passage from the seed pool into the seed exit chute.

Example 4—the seed meter of Example 1, further including a baffle member disposed on the seed-side of the seed disc within the housing, the baffle member movable between selectable positions to regulate the seed entering the seed pool area from the seed inlet chute through the opening.

Example 5—the seed meter of Example 3, further including a baffle member disposed on the seed-side of the seed disc within the housing, the baffle member movable between selectable positions to regulate the seed entering the seed pool area from the seed inlet chute through the opening.

Example 6—the seed meter of Example 5, wherein the seed retaining structure is supported on the baffle member such that the seed retaining structure is movable together with the baffle member between the selectable positions.

Example 7—the seed meter of Example 5, wherein a portion of the brush comprising the seed retaining structure is supported on the baffle member such that the portion of the brush is movable together with the baffle member between the selectable positions.

Example 8—the seed meter of Example 2, wherein the brush includes a first brush portion and a second brush portion disposed at an angle with respect to one another.

Example 9—the seed meter of Example 2, wherein the first brush portion and second brush portion are disposed at an angle with respect to one another forming an upward apex.

The foregoing description and drawings are intended to be illustrative and not restrictive. Various modifications to the embodiments and to the general principles and features of the row unit 10, the seed meter 100, the baffle member 180, and the seed retaining structure 200 described herein will be apparent to those of skill in the art. Thus, the disclosure should be accorded the widest scope consistent with the appended claims and the full scope of the equivalents to which such claims are entitled.

1. A seed meter, comprising:
a housing defining a seed inlet chute, a seed exit chute and a seed pool area, the seed inlet chute adapted to receive seed from a seed supply, the housing having an opening through which the seed passes from the seed inlet chute to the seed pool area;
a cover removably attached to the housing, the cover including a vacuum port adapted to be in communication with a vacuum source;
a seed disc rotatably disposed between the housing and the cover, the seed disc having a seed-side toward the housing and a vacuum-side toward the cover, the seed disc having a plurality of apertures adapted to carry the seeds from the seed pool area to the seed exit chute as the seed disc rotates when a vacuum is applied on the vacuum-side of the seed disc by the vacuum source via the vacuum port;
a generally vertical brush disposed on the seed-side of the seed disc within the housing, the generally vertical brush separating the seed exit chute from the seed pool area;
a seed retaining structure disposed on the seed-side of the seed disc within the housing, the seed retaining structure disposed to prevent the seed within the seed pool area from passing over the generally vertical brush from the seed pool area into the seed exit chute.

2. The seed meter of claim 1, wherein the seed retaining structure includes a brush disposed generally transverse to the generally vertical brush.

3. The seed meter of claim 2, wherein the seed retaining structure defines a seed passage adjacent to the generally vertical brush, the seed retaining structure further including a flap, the flap disposed to swing by force of gravity between a generally vertical open position and a closed position, wherein in the closed position, the seed passage is closed by the flap preventing the seed from passing through the seed passage from the seed pool into the seed exit chute.

4. The seed meter of claim 1, further including a baffle member disposed on the seed-side of the seed disc within the housing, the baffle member movable between selectable positions to regulate the seed entering the seed pool area from the seed inlet chute through the opening.

5. The seed meter of claim 3, further including a baffle member disposed on the seed-side of the seed disc within the housing, the baffle member movable between selectable positions to regulate the seed entering the seed pool area from the seed inlet chute through the opening.

6. The seed meter of claim 5, wherein the seed retaining structure is supported on the baffle member such that the seed retaining structure is movable together with the baffle member between the selectable positions.

7. The seed meter of claim 5, wherein a portion of the brush comprising the seed retaining structure is supported on the baffle member such that the portion of the brush is movable together with the baffle member between the selectable positions.

8. The seed meter of claim 2, wherein the brush includes a first brush portion and a second brush portion disposed at an angle with respect to one another.

9. The seed meter of claim 2, wherein the first brush portion and second brush portion are disposed at an angle with respect to one another forming an upward apex.
